(19) United States
(12) Patent Application Publication
(10) Pub. No.: US 2008/0066025 A1
(43) Pub. Date: Mar. 13, 2008

(54) Method for analyzing characteristic of circuit included in integrated circuit based on process information and the like

(76) Inventor: Masakazu Tanaka, Kyoto (JP)

Correspondence Address: MCDERMOTT WILL & EMERY LLP, 600 13TH STREET, NW, WASHINGTON, DC, 20005-3096, US

(21) Appl. No.: 11/892,845

(22) Filed: Aug. 28, 2007

(30) Foreign Application Priority Data
Sep. 7, 2006 (JP) 2006-243099
Nov. 10, 2006 (JP) 2006-305472
Jun. 22, 2007 (JP) 2007-165413

(51) Int. Cl. G06F 17/50

(52) U.S. Cl. 716/4

(57) ABSTRACT

A circuit analyzing method of the present invention comprises the steps of (a) applying, for a characteristic having a variation width of characteristics of an element included in a circuit to be analyzed, any one of a maximum value and a minimum value of the variation width as a representative value of the characteristic of the element and (b) estimating a characteristic of the circuit to be analyzed, using the representative value.

### CROSS REFERENCE TO RELATED APPLICATIONS

This Non-provisional application claims priority under 35 U.S.C. §119(a) on Patent Application No. 2006-243099 filed in Japan on Sep. 7, 2006, Patent Application No. 2006-305472 filed in Japan on Nov. 10, 2006, and Patent Application No. 2007-165413 filed in Japan on Jun. 22, 2007, the entire contents of which are hereby incorporated by reference.

### BACKGROUND OF THE INVENTION

1. Field of the Invention

The present invention relates to a technique of simulating a characteristic of a circuit based on process information in design of a semiconductor integrated circuit.

2. Description of the Related Art

In design of semiconductor integrated circuits, advances in miniaturization have led to an increase in influence of process variations on circuit characteristics. Conventionally, variations in delay in each device included in an integrated circuit may be represented by a normal distribution, and a delay distribution in the whole circuit may be estimated by statistical calculation (this technique is hereinafter referred to as a statistical delay analyzing technique). The statistical delay analyzing technique statistically analyzes variations in delay in a circuit to be analyzed, using device characteristic information indicating variations in devices. The statistical delay analyzing technique is different from a general static delay analyzing technique which handles a delay as a fixed value in that a delay can be represented by a distribution, and a delay distribution of a circuit can be estimated in view of the shape of the distribution.

However, in the conventional statistical delay analyzing technique, a distribution needs to be calculated in the course of calculation of a path delay in a circuit. Therefore, as compared to the general static delay analysis, a considerably long processing time is required. Particularly in large-scale circuits including several millions of devices, the processing time is not practical.

### SUMMARY OF THE INVENTION

A circuit analyzing method of the present invention is a method for analyzing a characteristic of a circuit included in an integrated circuit, comprising the steps of (a) applying, for an element included in a circuit to be analyzed and having a characteristic represented as values having a variation width, any value within the variation width as a representative value of the characteristic of the element and (b) estimating a characteristic of the circuit to be analyzed, using the representative value.

According to the present invention, an influence of variations in an element, such as a device, a wire or the like, included in a semiconductor integrated circuit on a circuit characteristic can be estimated in a short processing time. Even when each device varies at a maximum level, it can be determined whether or not a desired circuit characteristic can be maintained.

The circuit analyzing method of the present invention can calculate an influence of variations in an element included in an integrated circuit on a circuit characteristic in a short processing time, and therefore, is useful for verification of a characteristic of an integrated circuit in a miniaturization process having an increased change amount.

### BRIEF DESCRIPTION OF THE DRAWINGS

FIG. 1 is a flowchart of circuit analysis according to a first embodiment.

FIG. 2 shows exemplary circuit information.

FIG. 3 shows exemplary process characteristic information about a wire.

FIG. 4 shows exemplary process characteristic information about an inverter.

FIG. 5 shows other exemplary process characteristic information about an inverter.

FIG. 6 shows exemplary variation item information.

FIG. 7 shows exemplary variation condition information.

FIG. 8 is a flowchart of a variation condition generating means.

FIG. 9 is a flowchart of a variation condition generating means.

FIG. 10 is a flowchart of a variation condition generating means.

FIG. 11 shows exemplary variation item information depending on an evaluation index.

FIG. 12 shows exemplary variation condition information depending on an evaluation index.

FIG. 13 shows exemplary variation amount information.

FIG. 14 shows exemplary circuit information.

FIG. 15 shows exemplary process characteristic information.

FIG. 16 is a flowchart of circuit analysis according to a second embodiment.

FIGS. 17A to 17C show exemplary variation item information.

FIGS. 18A to 18C show exemplary variation item information which is obtained by hierarchical grouping.

FIGS. 19A and 19B show exemplary variation condition information when all patterns are extracted.

FIGS. 20A and 20B show exemplary variation condition information which is obtained by specification.

FIG. 21 is a flowchart of a process of grouping variation items.

FIG. 22 shows exemplary grouping pattern information.

FIG. 23 is a flowchart of a process of grouping variation items.

FIG. 24 is a flowchart of circuit analysis according to a third embodiment.

FIG. 25 shows exemplary process characteristic information.

FIG. 26 is a flowchart of circuit analysis according to a fourth embodiment.

FIG. 27 shows an exemplary layout corresponding to a circuit to be analyzed.

FIG. 28 is a flowchart of a layout-dependent variation condition generating method.

FIG. 29 shows exemplary layout pattern-dependent characteristic information.

FIG. 30 shows an exemplary layout corresponding to a circuit to be analyzed.

FIG. 31 shows exemplary layout-dependent characteristic information in view of a gate shape.

FIG. 32 shows an exemplary layout of a circuit to be analyzed.

FIG. 33 shows exemplary layout-dependent characteristic information in view of the number of wires passing over a device.

FIG. 34 shows an exemplary layout corresponding to a circuit to be analyzed.

FIG. 35 shows exemplary layout-dependent characteristic information in view of an inter-device distance.

FIG. 36 shows an exemplary layout corresponding to a circuit to be analyzed.

FIG. 37 shows exemplary layout-dependent characteristic information in view of a transistor diffusion shared number.

FIG. 38 shows an exemplary layout corresponding to a circuit to be analyzed.

FIG. 39 shows exemplary layout-dependent characteristic information in view of a well size.

FIG. 40 shows an exemplary layout corresponding to a circuit to be analyzed.

FIG. 41 shows exemplary layout-dependent characteristic information in view of a via-wire end distance.

FIG. 42 shows an exemplary layout corresponding to a circuit to be analyzed.

FIG. 43 shows exemplary layout-dependent characteristic information in view of an inter-wire distance.

FIG. 44 shows an exemplary layout corresponding to a circuit to be analyzed.

FIG. 45 is a flowchart of a layout-dependent variation condition generating method.

FIG. 46 shows exemplary layout density-dependent characteristic information.

FIG. 47 shows an exemplary layout corresponding to a circuit to be analyzed.

FIG. 48 is a flowchart of a layout-dependent variation condition generating method.

FIG. 49 shows exemplary layout distance-dependent characteristic information.

FIG. 50 is a flowchart of a layout-dependent variation condition generating method.

FIG. 51 shows exemplary layout hierarchy-dependent characteristic information.

FIG. 52 shows exemplary variation condition information.

FIG. 53 shows exemplary process characteristic information.

FIG. 54 shows exemplary process characteristic information.

FIG. 55 shows exemplary process characteristic information.

FIG. 56 is a flowchart of a circuit analyzing method according to an eighth embodiment.

FIG. 57 shows exemplary circuit information.

FIG. 58 shows exemplary delay analysis result information.

FIG. 59 shows exemplary path selection information.

FIG. 60 is a flowchart of the circuit analyzing method of the eighth embodiment.

FIG. 61 shows exemplary device characteristic information.

FIG. 62 shows exemplary device characteristic information.

FIG. 63 shows exemplary device characteristic information.

FIGS. 64A and 64B show exemplary device characteristic information.

FIGS. 65A and 65B show exemplary device characteristic information.

FIGS. 66A and 66B show exemplary device characteristic information.

FIGS. 67A and 67B show exemplary device characteristic information.

FIG. 68 shows exemplary device characteristic information.

FIG. 69 shows exemplary device characteristic information.

FIG. 70 is a flowchart of the circuit analyzing method of the eighth embodiment.

FIG. 71 is a flowchart of the circuit analyzing method of the eighth embodiment.

### DETAILED DESCRIPTION OF THE PREFERRED EMBODIMENTS

Hereinafter, embodiments of the present invention will be described with reference to the accompanying drawings. Note that like parts are indicated by like reference numerals and will not be repeatedly described.

### First Embodiment

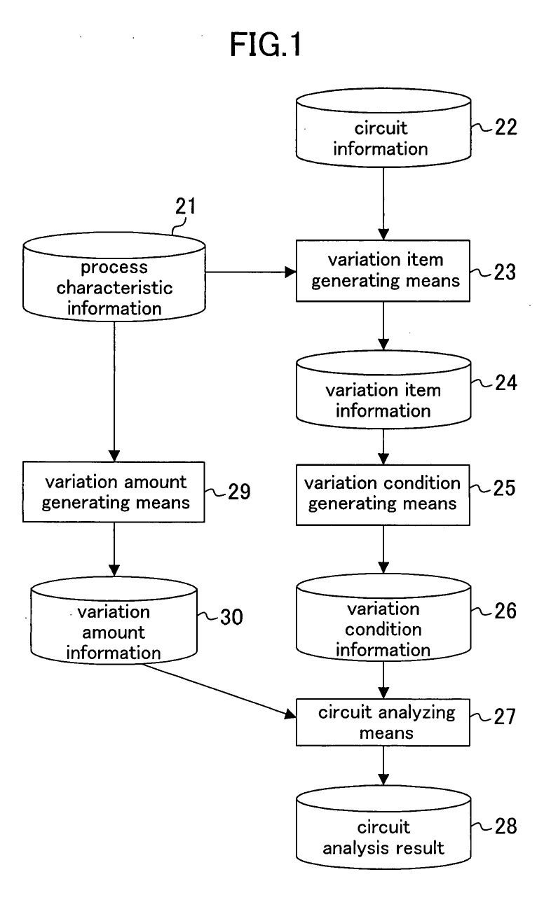

A flow of a circuit analyzing method according to a first embodiment is shown in FIG. 1. The circuit analyzing method of this embodiment is implemented as a program for causing a computer to execute the flow of FIG. 1 or a device for executing the flow (e.g., a computer for executing the program). Note that the same is true of other embodiments described below.

<Input Data>

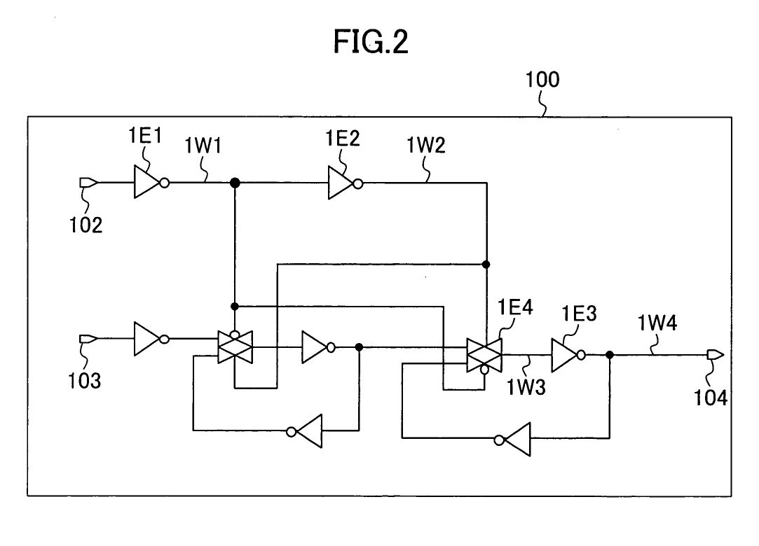

FIG. 2 shows exemplary circuit information 22 which is to be analyzed by the circuit analyzing method of this embodiment. A method for analyzing a delay in a path from an input terminal 102 to an output terminal 104 (one of the characteristics of a circuit 100) in view of variations in devices 1E1 to 1E4 and wires 1W1 to 1W4 which are elements included in the circuit 100, will be described.

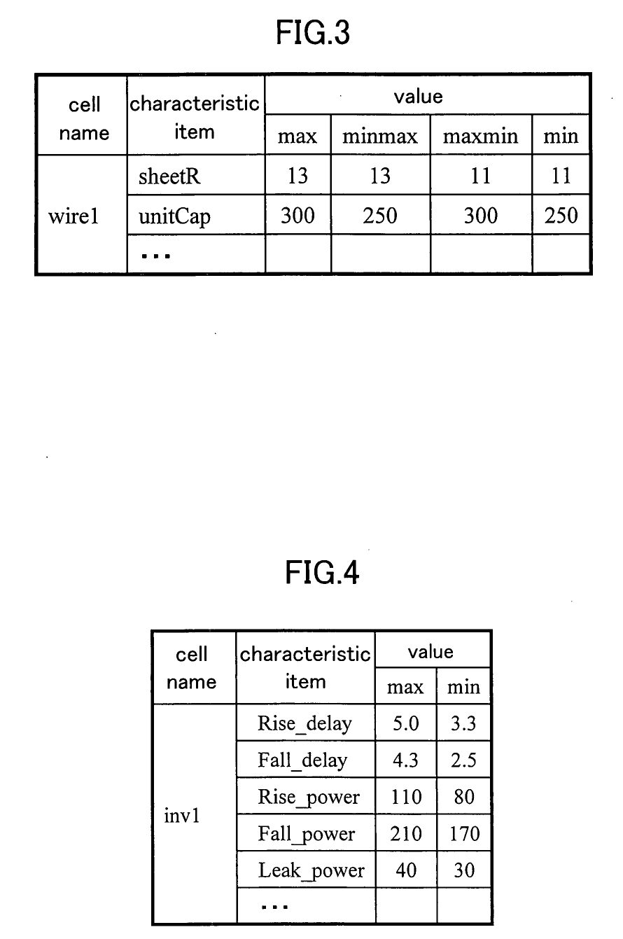

FIGS. 3 to 5 show exemplary process characteristic information 21. The process characteristic information 21 includes information about the upper limit value, the lower limit value and the like of variations in each characteristic of the elements included in the circuit.

FIG. 4 shows characteristics of an inverter (inv1) for a process of interest, i.e., the maximum and minimum of a delay in rise (Rise_delay) are 5.0 and 3.3, respectively, and the maximum and minimum of a delay in fall (Fall_delay) are 4.3 and 2.5, respectively. FIG. 4 indicates that each characteristic completely varies with correlation. As representative values, the maximum is defined as max and the minimum is defined as min. When a representative value of a characteristic of the inverter is max, the rise delay and the fall delay both have maximum variations. When a representative value of a characteristic of the inverter is min, the rise delay and the fall delay both have minimum variations.

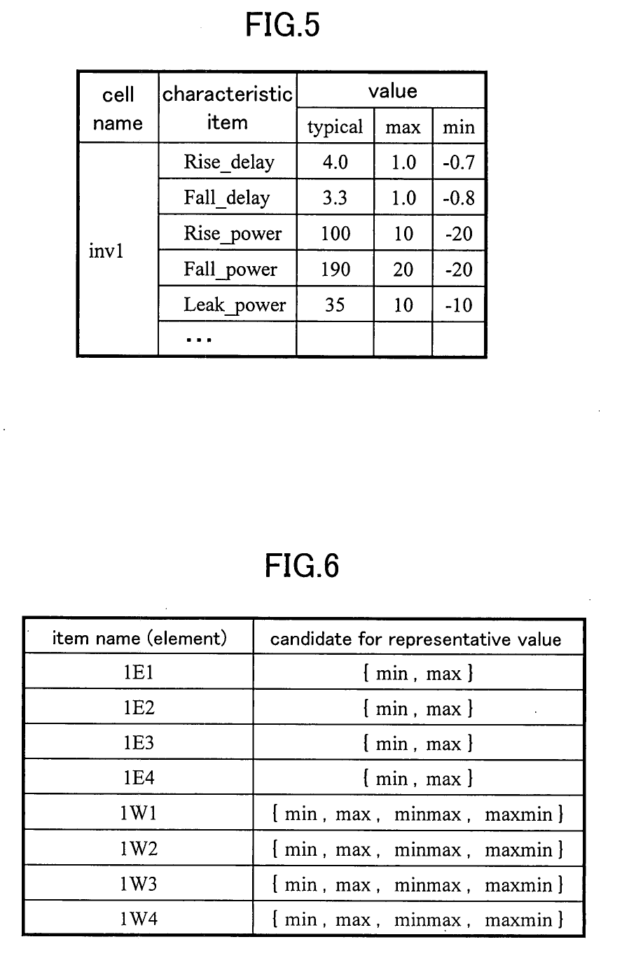

On the other hand, FIG. 5 shows another exemplary expression of characteristics of the inverter for the process of interest. The rise delay (Rise_delay) has a typical value (typical) of 4.0, a maximum (max) of +1.0, and a minimum (min) of −0.7. The fall delay (Fall_delay) has a typical value (typical) of 3.3, a maximum (max) of +1.0, and a minimum (min) of −0.8. The maximum (max) and minimum (min) values are indicated by relative values to the typical values (typical). As in FIG. 4, FIG. 5 also shows that the maximum and minimum of the rise delay (Rise_delay) are 5.0 and 3.3, respectively, and the maximum and minimum of the fall delay (Fall_delay) are 4.3 and 2.5, respectively.

Also, FIG. 3 shows exemplary characteristics of a wire for a process of interest. Here, as the characteristics of the wire (wire1) which is an element included in the circuit, two characteristics, i.e., a sheet resistance value (SheetR) and a unit capacitance value (unitCap), are indicated. It is shown that the sheet resistance value (SheetR) has a maximum of 13 and a minimum of 11, and the unit capacitance value (unitCap) has a maximum of 300 and a minimum of 250. It is also shown that the characteristics vary completely independently. In other words, combinations of the maximums and minimums of the two characteristics provide four representative values of variations, which are defined as max, minmax, maxmin, and min. Here, a case where the representative value of the characteristics of the wire is max indicates that the sheet resistance value (SheetR) and the unit capacitance value (unitCap) both have maximum variations, and a case where it is minmax indicates that the sheet resistance value (SheetR) has a maximum variation and the unit capacitance value (unitCap) has a minimum variation.

Thus, in this embodiment, variations in devices and wires are represented by the maximum and minimum values of variations in characteristics, thereby making it possible to similarly handle variations in devices and wires.

<Generation Of Variation Items>

Initially, a variation item generating means 23 extracts elements of the circuit to be subject to variation from the process characteristic information 21 and the circuit information 22, and produces variation item information 24 by listing candidates for representative values of characteristics of each device.

FIG. 6 shows exemplary variation item information 24 corresponding to FIGS. 2 to 4.

As shown in FIG. 6, there are two candidates (i.e., min and max) for representative values of a characteristic (delay) of the inverters 1E1 to 1E3 and the multiplexer 1E4, and four candidates (i.e., min, max, minmax, and maxmin) for representative values of characteristics (a combination of sheet resistance and unit capacitance) of the wires 1W1 to 1W4.

<Generation of Variation Conditions>

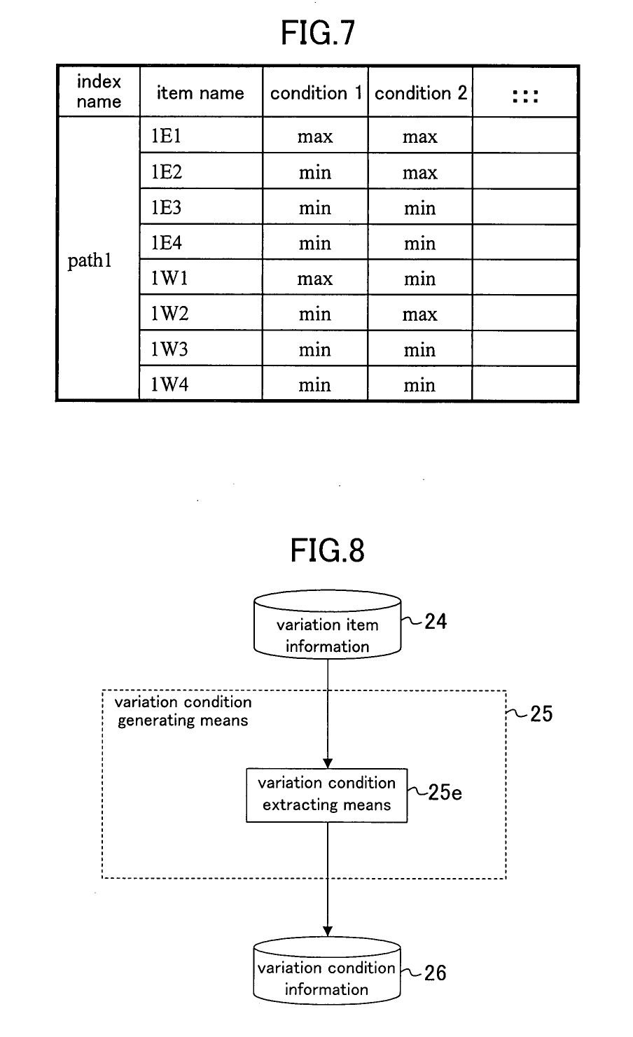

Next, a variation condition generating means 25 determines the representative values of each device based on the variation item information 24. FIG. 7 shows exemplary variation condition information 26 corresponding to the variation item information 24 of FIG. 6. Under a condition 1, the representative values of the characteristics of 1E1 and 1W1 are max, and the representative values of the characteristics of 1E2 to 1E4 and 1W2 to 1W4 are min. Under a condition 2, the representative values of the characteristics of 1E1, 1E2 and 1W2 are max, and the representative values of the characteristics of 1E3, 1E4, 1W1, 1W3 and 1W4 are min.

<Details of Variation Condition Generating Method>

In order to generate the variation condition information, all possible patterns may be extracted or alternatively a portion of all possible patterns may be selected.

FIG. 8 is a diagram showing a flow when all patterns are selected. A variation condition extracting means 25e generates all combination patterns of items with respect to each element based on the variation item information 24 to generate the variation condition information 26. In the case of the variation item information 24 of FIG. 6, the number of combinations is 4096 as shown in (Expression 1). In the variation condition extracting means 25e, all of these 4096 combinations are extracted and stored into the variation condition information 26.

2×2×2×2×4×4×4×4=4096 (Expression 1)

When all patterns are selected, the worst pattern can be detected with certainty irrespective of the ability of a designer, and the possibility that a human error occurs is small. It is most advantageous when the number of combinations is not huge and therefore the calculation processing time required for circuit analysis is not problematic.

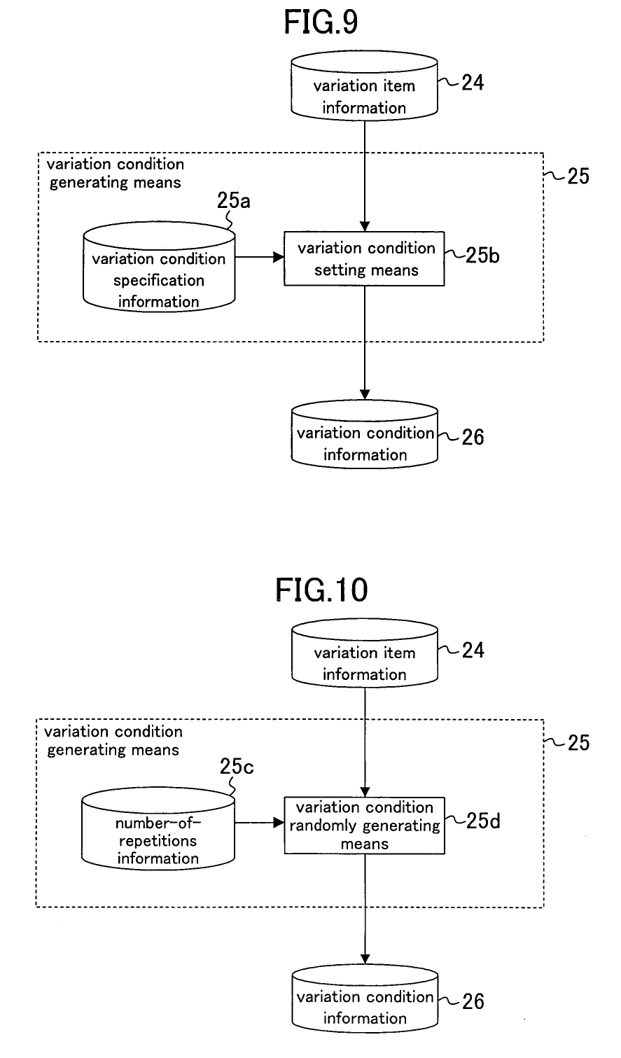

On the other hand, when a portion of all patterns is selected, they may be randomly generated or may be specified by the designer. FIG. 9 is a diagram showing a flow when a variation condition is specified and selected by the designer. Variation condition specification information 25a is information about a variation condition specified by the designer. The variation condition specification information 25a may be arbitrarily produced by the designer or may be selected from variation condition information about all patterns extracted by the variation condition extracting means 25e. A variation condition setting means 25b generates all combination patterns of items for each device based on variation item information 24 to generate variation condition information 26.

When a variation condition which should be evaluated with highest priority can be specified by the designer or a variation condition which does not need to be evaluated is clearly known, a minimum level of analysis can be most efficiently performed by the designer specifying a variation condition. It is particularly effective when the number of devices which are subject to variation is large or the like.

FIG. 10 is a diagram showing a flow when a pattern is randomly selected. A variation condition randomly generating means 25d randomly selects a representative value from candidates for the representative value for each element specified by the variation item information 24 to generate a combination pattern of representative values and thereby generate variation condition information 26. The number of combination patterns to be generated is determined based on number-of-repetitions information 25c which is previously specified.

In the randomly generating method, a most appropriate number of combinations can be randomly generated based on a trade-off between a processing time and a required precision. Thereby, it is possible to efficiently estimate a variation in a circuit characteristic with a certain probability. When the number of devices which are subject to variation is large and it is difficult for the designer to select an item, it is most effective.

<Variation Item Information For Each Index>

On the other hand, when a delay is evaluated as an evaluation index for analysis in the circuit 100 of interest, the representative values minmax and maxmin of a wire do not need to be analyzed. Similarly, when power consumption is evaluated, the representative values min and max of a wire do not need to be analyzed. In this case, by allowing candidates required for representative values of characteristics of each element for each evaluation index to be selected instead of generating the four items (min, max, minmax, and maxmin) as candidates for representative values of characteristics of a wire, the processing time can be further reduced.

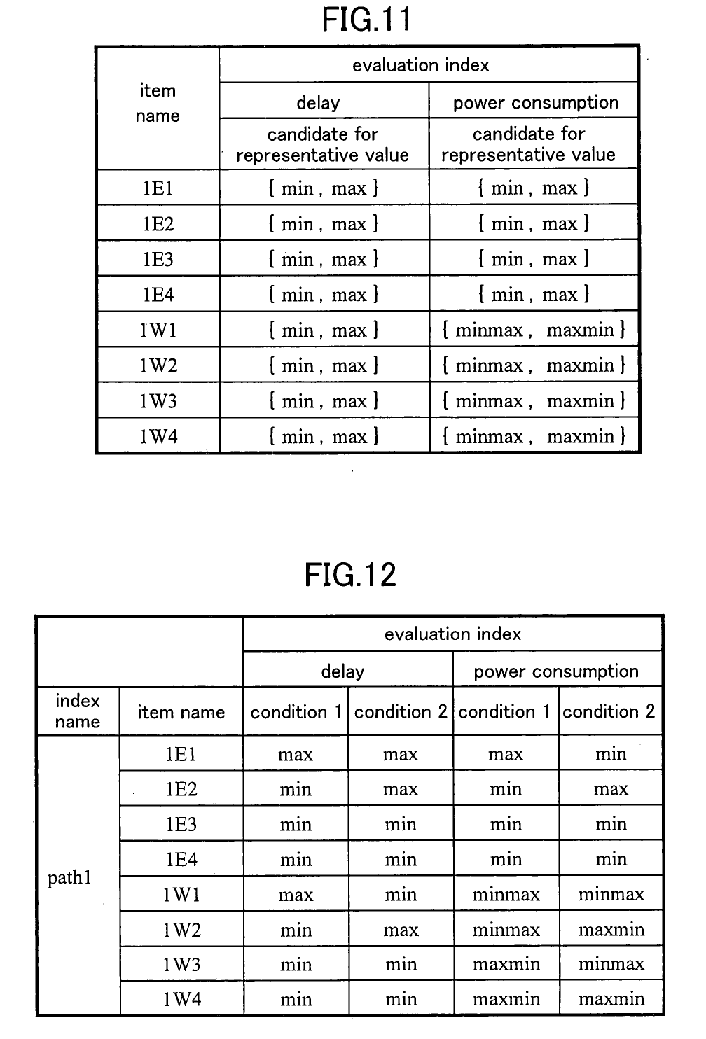

FIG. 11 shows other exemplary variation item information corresponding to FIGS. 2 to 4. When the evaluation index is a delay, only two patterns, i.e., min and max, can be selected as candidates for a representative value of not only a device but also a wire. On the other hand, when the evaluation index is power consumption, two patterns, i.e., minmax and maxmin, can be selected as candidates for a representative value of a characteristic of a wire.

FIG. 12 shows exemplary variation condition information corresponding to FIG. 11. When the evaluation index is a delay, a representative value of a characteristic of both a device and a wire is selected from candidates for two patterns, i.e., min and max. When the evaluation index is power consumption, a representative value of a characteristic of a device is selected from candidates for two patterns, i.e., min and max, and a representative value of a characteristic of a wire is selected from candidates for two patterns, i.e., minmax and maxmin.

<Generation of Variation Amount>

A variation amount generating means 29 generates variation amount information 30 which represents candidates for representative values corresponding to variation item information as actual numerical values, from values of variation amounts of the process characteristic information 21. FIG. 13 shows exemplary variation amount information corresponding to FIGS. 2 to 4 and 6. Candidates for representative values of variations of characteristics for each element are listed as numerical values.

<Circuit Analysis>

A circuit analyzing means 27 assigns numerical values corresponding to representative values (min, max, etc.) set in each variation condition (the condition 1, the condition 2, etc.) of the variation condition information 26 based on the variation amount information 30 to perform circuit analysis (e.g., Monte Carlo simulation) under each variation condition. A total simulation time is substantially proportional to the number of variation conditions.

### Second Embodiment

<Grouping>

Next, a second embodiment of the present invention will be described.

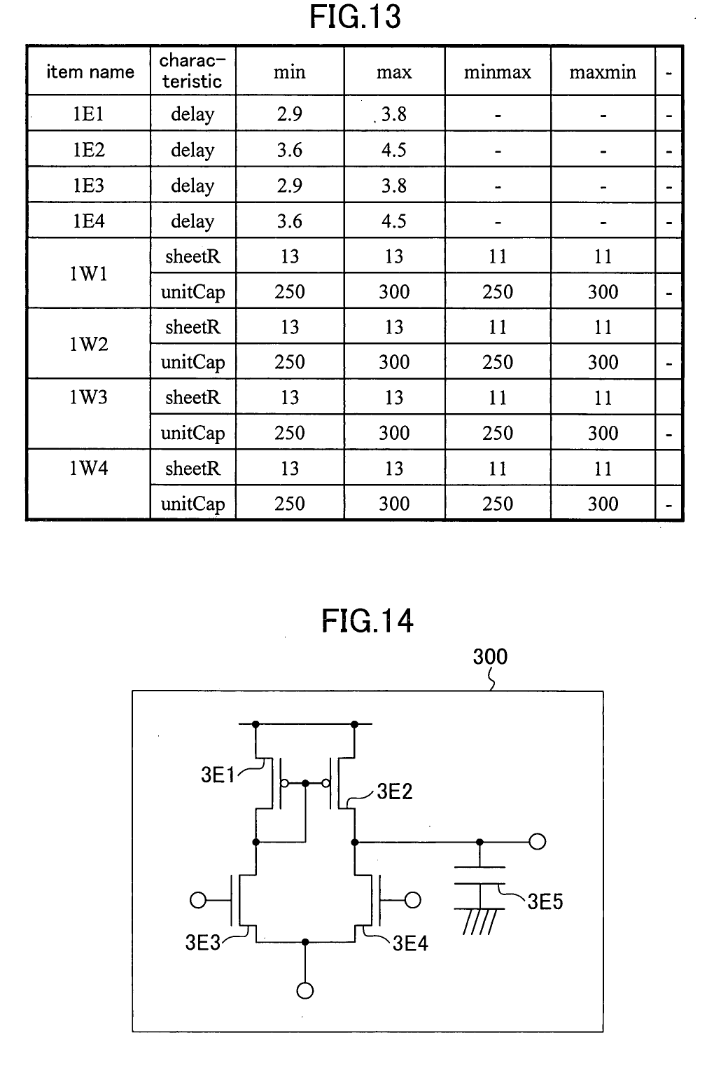

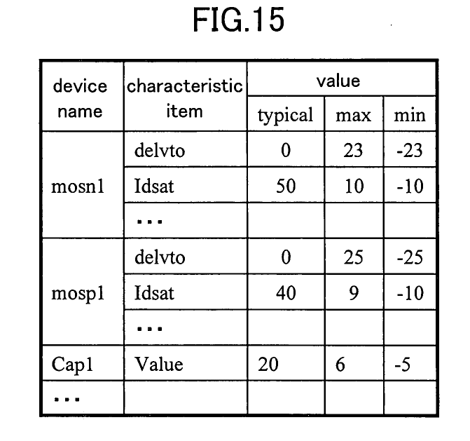

FIG. 14 shows exemplary circuit information 22 which is to be analyzed by a circuit analyzing method of this embodiment. A method for analyzing a characteristic of a circuit 300 in view of variations in devices 3E1 to 3E4 and a capacitance device 3E5 which are included in the circuit 300, will be described. FIG. 15 shows exemplary process characteristic information 21. Maximum and minimum values of variations of change amounts (delvto) of threshold voltages and saturated drain currents (Idsat) of an NMOS (mosn1) and a PMOS (mosp1) are set. A variation width of a capacitance value (value) of a capacitance device (Cap1) is set.

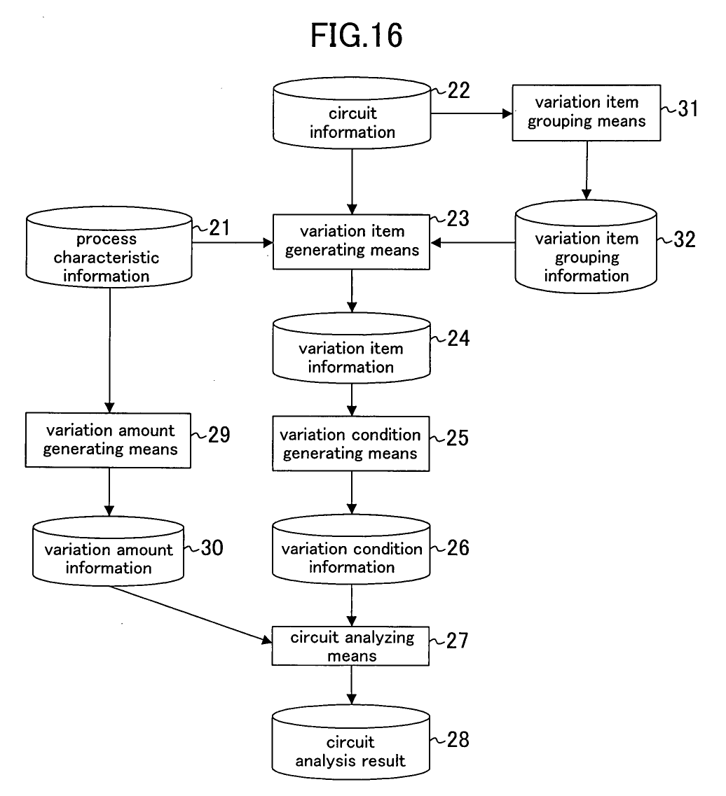

FIG. 16 shows a flow of a circuit analyzing method according to this embodiment. A variation item grouping means 31 groups a portion of circuit connection relationships and groups variation items based on the circuit information 22 to generate variation item grouping information 32.

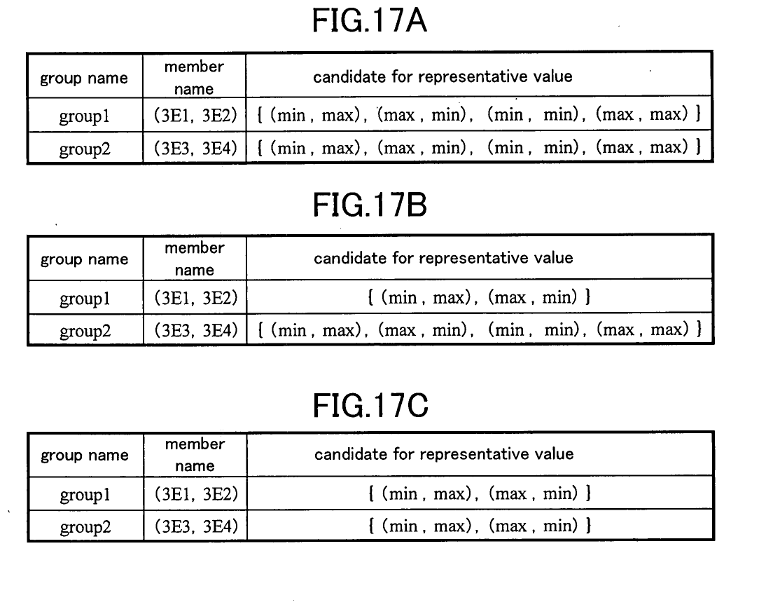

FIG. 17A shows exemplary variation item information 24 corresponding to FIG. 14. 3E1 and 3E2 are grouped into group1 while 3E3 and 3E4 are grouped into group2. Thus, in this embodiment, the variation item generating means 23 generates, for each group, variation item information 24 in which combinations of variables representing maximum values and minimum values of variation widths of characteristics of elements included in the group are listed as candidates for representative values of the group. In this case, as candidates for representative values of each group, all four items, i.e., (min, max), (max, min), (min, min), and (max, max), may be generated or alternatively only required item(s) can be used as candidates. For example, in group1, when 3E1 and 3E2 both have min (i.e., verification when 3E1 and 3E2 both have max is not required), candidates for representative values of group1 are limited to a combination (min, max) in which 3E1 has min and 3E2 has max and a combination (max, min) in which 3E1 has max and 3E2 has min as shown in FIG. 17B. Alternatively, as shown in FIG. 17C, candidates for representative values of group1 are limited to a combination (min, max) in which 3E1 has min and 3E2 has max and a combination (max, min) in which 3E1 has max and 3E2 has min, and candidates for representative values of group2 are limited to a combination (min, max) in which 3E3 has min and 3E4 has max and a combination (max, min) in which 3E3 has max and 3E4 has min. Thereby, it is possible to reduce the processing time.

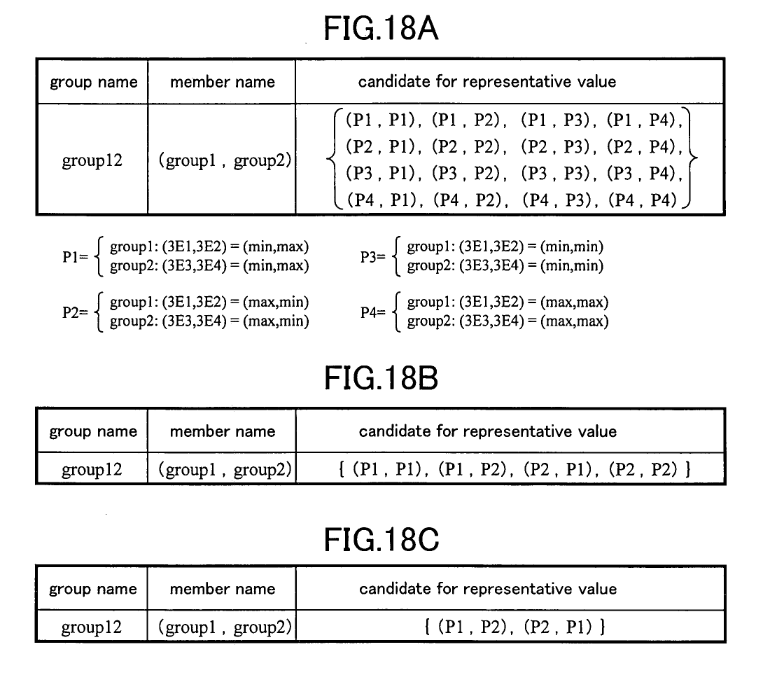

Further, grouping can be performed in a hierarchical manner. FIG. 18A shows exemplary variation item information 24 which is obtained by hierarchical grouping. Group1 and group2 are grouped into group12. Note that, in FIG. 18A, (P1, P1) which is one candidate for representative values of group12 indicates that the combination pattern of representative values of group1 is P1 and the combination pattern of representative values of group2 is P1. The combination pattern P1 of representative values of group1 is a combination (min, max) in which 3E1 has min and 3E2 has max as shown in FIG. 18A. The same is true of the other patterns.

In this case, all 16 items including (P1, P1) to (P4, P4) may be generated as candidates for representative values of group12 or alternatively only a required item(s) can be generated as a candidate(s). For example, if verification is not required when at least one of group1 and group2 has P3 and when at least one of group1 and group2 has P4, candidates for representative values of group12 can be limited to four items, i.e., (P1, P1), (P1, P2), (P2, P1), and (P2, P2), as shown in FIG. 18B. In FIG. 18C, further, a case where both group1 and group2 have P1 and a case where both group1 and group2 have P2 are excluded, i.e., candidates for representative values of group12 are limited to a case where group1 has P1 and group2 has P2 and a case where group1 has P2 and group2 has P1. In this case, combinations of candidates for representative values of the elements (3E1, 3E2, 3E3, 3E4) in group12 are limited to two combinations, i.e., (min, max, max, min) and (max, min, min, max).

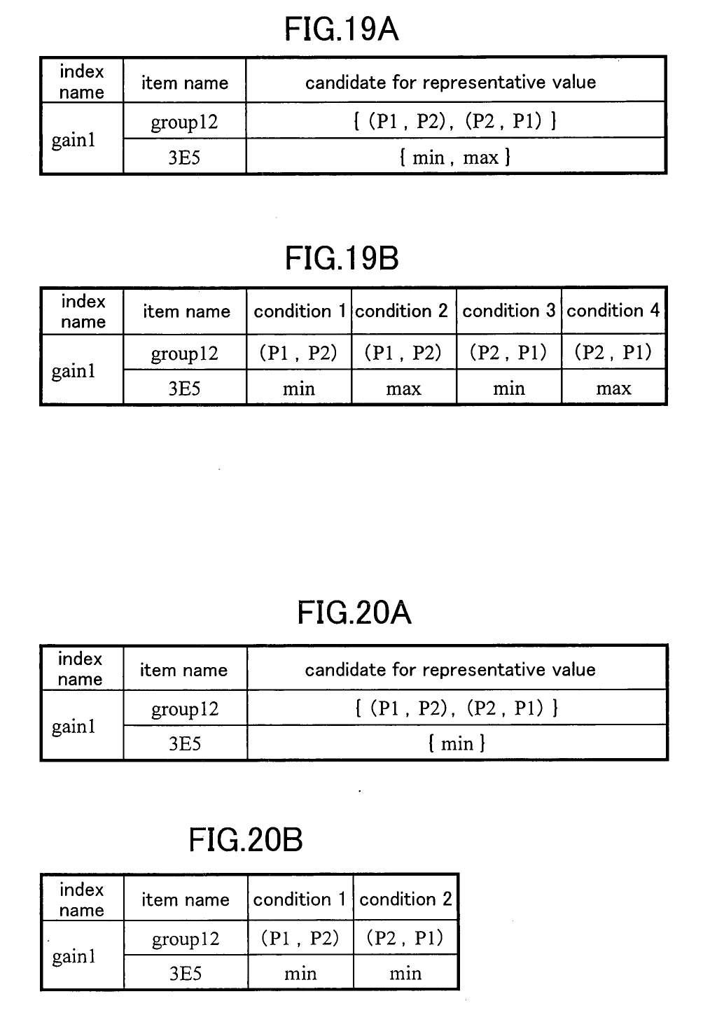

When candidates for representative values of group 12 are limited as shown in FIG. 18C, variation item information 24 about the circuit 300 of FIG. 14 is as shown in FIG. 19A. FIG. 19B shows exemplary variation condition information 26 when the variation condition extracting means 25e in the variation condition generating means 25 extracts all patterns from the variation item information 24 of FIG. 19A.

The circuit analyzing means 27 performs simulation the number of combinations (variation conditions) of representative values using a maximum value or a minimum value from the process characteristic information of FIG. 15, depending on whether the representative value of each device is min or max. A total simulation time is substantially proportional to the number of combinations (variation conditions) of representative values.

Variation conditions of the circuit information 300 include four conditions 1 to 4 of FIG. 19B by the grouping. The number of combinations of representative values of variations of the five devices (i.e., 3E1 to 3E5) is 32 according to (Expression 2) when grouping is not performed, so that the speed is increased by a factor of 8.

2×2×2×2×2=32

Further, if the designer can determine that verification is not required when the capacitance device 3E5 has max and it is sufficient that circuit analysis is performed only when the capacitance device 3E5 has min, variation conditions can be further reduced. In this case, variation item information 24 about the circuit 300 of FIG. 14 is as shown in FIG. 20A. FIG. 20B shows exemplary variation condition information 26 generated when variation conditions are limited only to the conditions 1 and 3 of FIG. 19B by the variation condition setting means 25b. Since there are two variation conditions, the speed can be increased by a factor of 2 as compared to FIG. 19A and by a factor of 16 as compared to 32 variation conditions when grouping is not performed.

<Details of Grouping>

The variation item grouping information 32 is generated by a method in which the designer specifies and groups variation items or a method in which variation items are automatically extracted and grouped based on variation item grouping pattern information 31c which is previously specified.

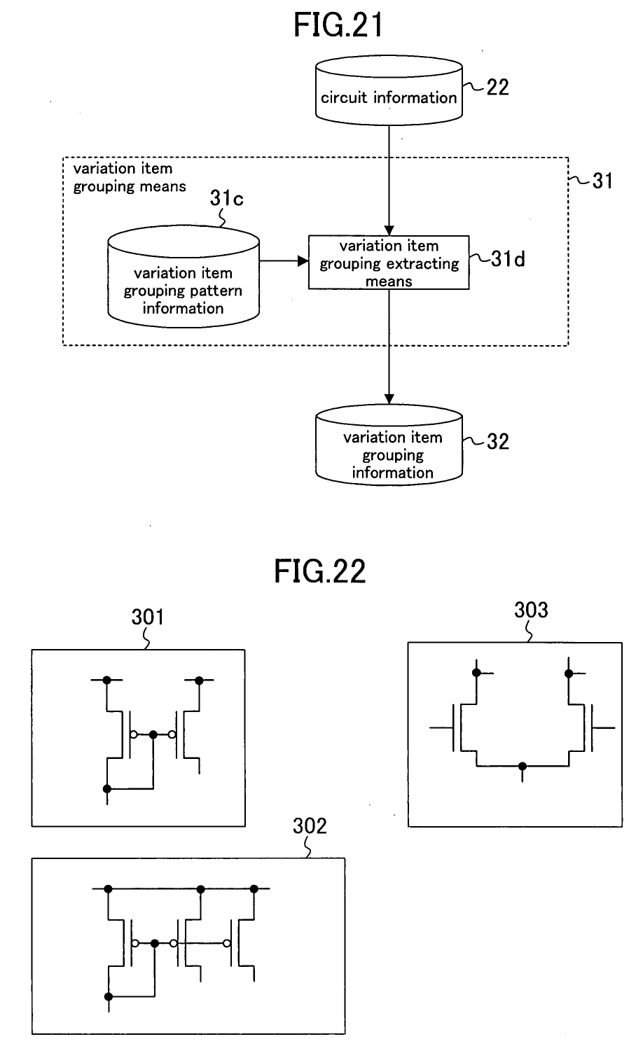

FIG. 21 is a diagram showing a flow of automatically performing grouping of variation items. Initially, a variation item grouping extracting means 31d extracts a pattern matching the variation item grouping pattern information 31c from element connection relationships in the circuit information 22. FIG. 22 shows exemplary grouping pattern information 31c. In the circuit 300 to be analyzed, 3E1 and 3E2 match a grouping pattern 301 and 3E3 and 3E4 match a grouping pattern 303, so that the variation item grouping extracting means 31d generates grouping information 32 about these patterns. When connection patterns of devices to be subjected to grouping can be limited, by previously producing the variation condition grouping pattern information 31c, extraction for grouping can be automatically performed, so that the number of steps and errors due to manual setting can be reduced.

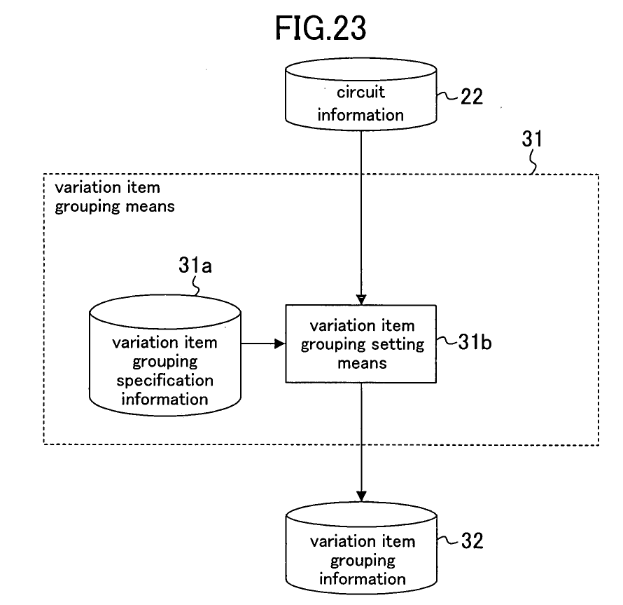

FIG. 23 is a diagram showing a flow when grouping is performed by specification by the designer. Based on variation item grouping specification information 31a in which a list of devices which are desired to be grouped or the like is previously specified by the designer, a variation item grouping setting means 31b can set grouping information. If grouping can be specified by the designer, then when it is, for example, difficult to previously specify patterns to be grouped since they are complicated, the designer specifies grouping, thereby making it possible to minimize variation items, resulting in a reduction in processing time.

### Third Embodiment

<Circuit-Dependent Variation Amount>

Transistors paired on a circuit are designed to have similar characteristics, such as the same shape, adjacent positions and the like, and therefore, relative variation amounts (mismatch) in the characteristics between the transistors are small. Therefore, the precision of circuit analysis can be improved by setting the variation amount to be a value which is substantially practical and optimal, depending on a feature of the circuit.

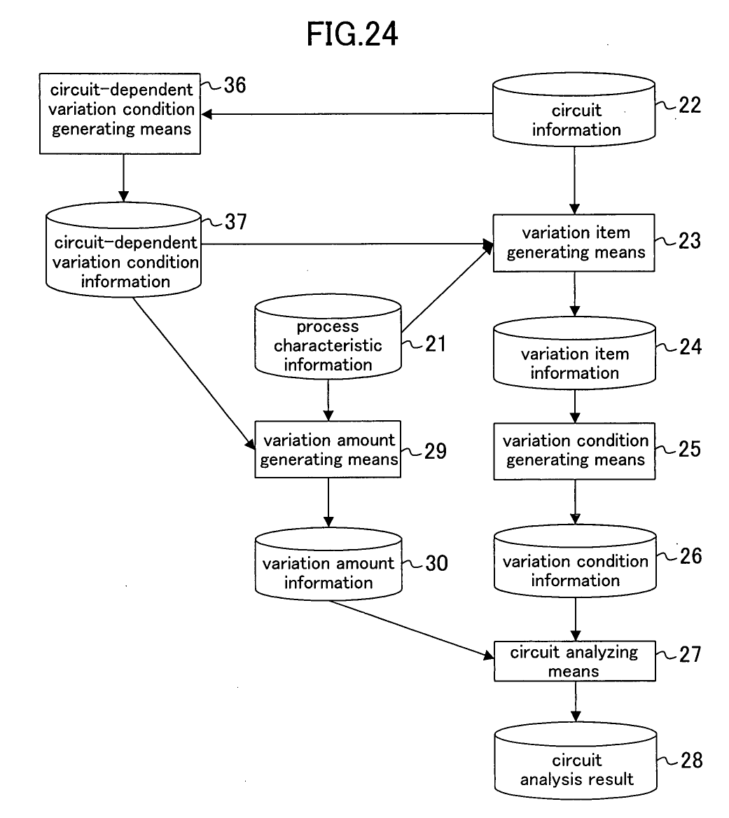

FIG. 24 is a flowchart of circuit analysis according to this embodiment. A circuit-dependent variation condition generating means 36 extracts a pair of transistors from the circuit information 22 to generate circuit-dependent variation condition information 37. A circuit-dependent variation condition can be generated by a method similar to the above-described variation item grouping means, including, for example, automatic extraction from the circuit information 22 based on the grouping information of FIG. 22 or specification by the designer.

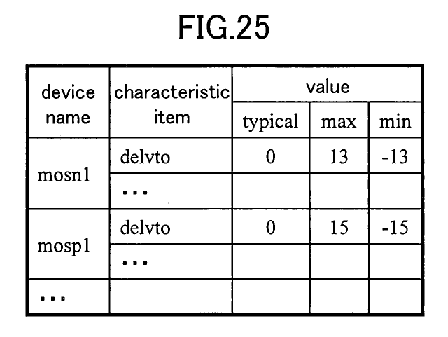

FIG. 25 shows an exemplary relative variation amount of a pair of transistors as process characteristic information 21. The value of delvto is smaller than that of FIG. 15. A variation amount generating means 29 generates variation amount information 30 in which a variation amount of a pair of transistors which are recognized in the circuit-dependent variation condition information 37 is set based on the process characteristic information 21.

In the variation amount information 30, a relative variation amount of a pair of transistors is set only for a pair of transistors in the circuit information 22, while an ordinary variation amount (e.g., a variation in a chip) is set for the other transistors, thereby making it possible to improve the precision of estimation of variations in circuit analysis.

### Fourth Embodiment

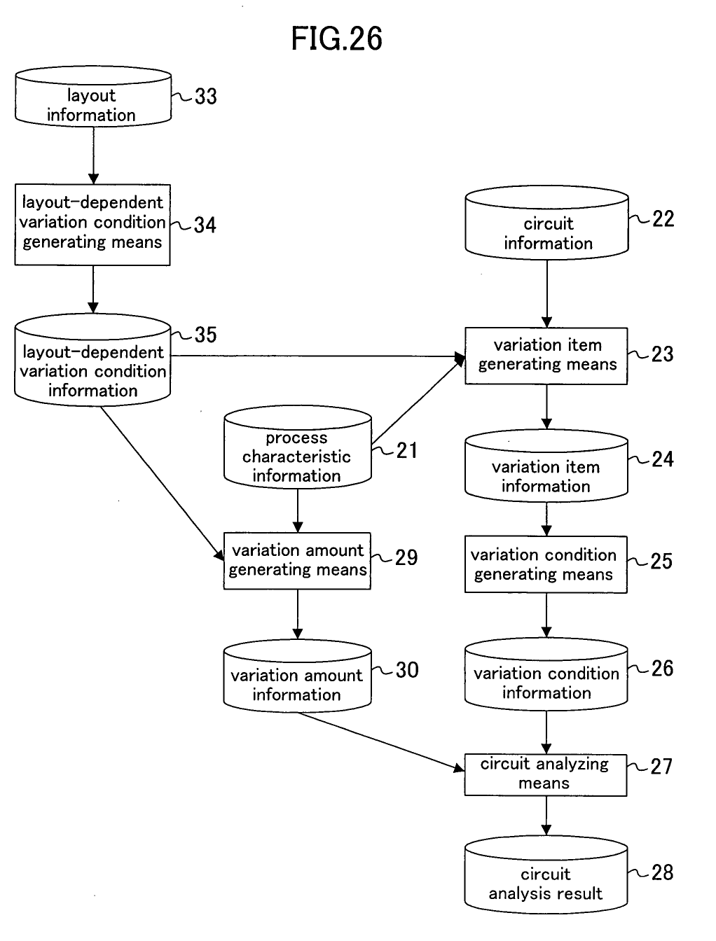

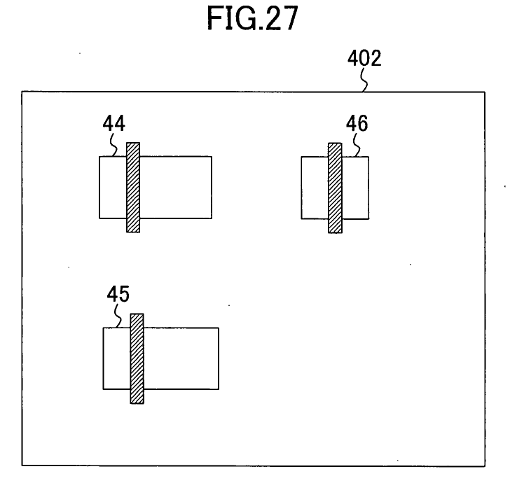

In this embodiment, an example in which circuit analysis is performed in view of a variation amount which varies depending on a feature of a layout. FIG. 26 is a flowchart of a circuit analyzing method according to this embodiment. A layout-dependent variation condition generating means 34 extracts a layout portion on which a variation amount is dependent, from layout information 33.

<Layout Pattern-Dependent Variation Amount>

FIG. 27 shows an exemplary layout 402 corresponding to a circuit to be analyzed. The layout 402 is stored in the layout information 33. In the layout 402, when attention is paid to the areas of diffusion regions of transistors 44 to 46, the diffusion areas of the transistors 44 and 45 are larger than that of the transistor 46.

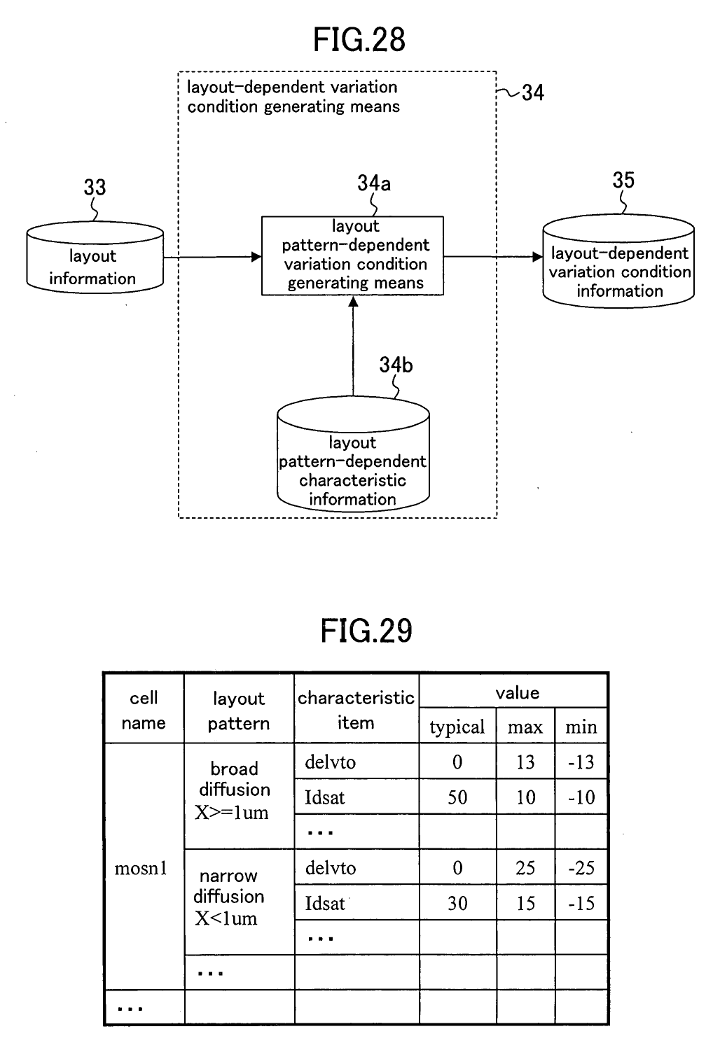

FIG. 28 is a flowchart of a layout-dependent variation condition generating method. FIG. 29 shows exemplary layout pattern-dependent characteristic information 34b. A layout pattern-dependent variation condition generating means 34a compares the layout information 33 with the layout pattern-dependent characteristic information 34b. The transistors 44 and 45 are recognized as having a larger diffusion area, and information about that is described into layout-dependent variation condition information 35. The variation amount generating means 29 generates variation amount information 30 based on a variation amount described in the layout-dependent variation condition information 35. Specifically, for the transistors 44 and 45 having a larger diffusion area, values of 0, 13 and −13 are applied to the typical, max and min of delvto, respectively, and values of 50, 10 and −10 are applied to the typical, max and min of Idsat, respectively. For the transistor 46, values of 0, 25 and −25 are applied to the typical, max and min of delvto, respectively, and values of 30, 15 and −15 are applied to the typical, max and min of Idsat, respectively.

Since a variation amount optimal to a characteristic of each device is set, depending on a layout pattern, the precision of estimation of variations in circuit analysis can be improved.

Other specific exemplary layout pattern-dependent variation amounts will be described below.

<Gate Shape-Dependent Variation Amount>

Next, an example in which circuit analysis is performed in view of a variation amount which varies depending on a gate shape, will be described.

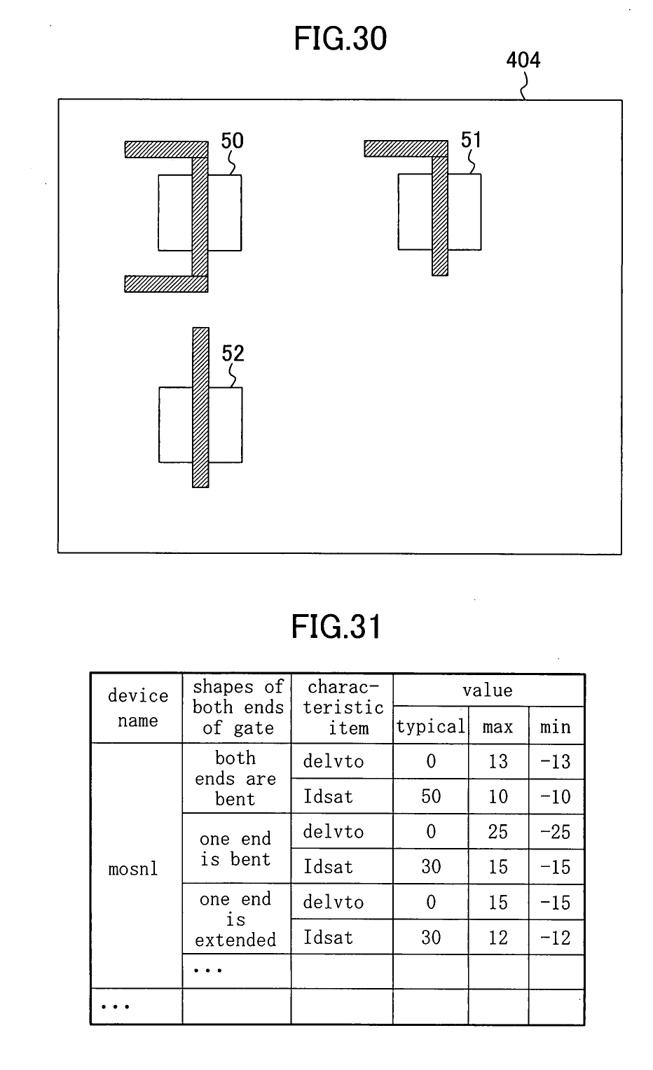

FIG. 30 shows an exemplary layout 404 corresponding to a circuit to be analyzed. The layout 404 is stored in the layout information 33 of FIG. 28. In the layout 404, when attention is paid to gate shapes of transistors 50 to 52, both ends of the gate of the transistor 50 are bent, only one end of the gate of the transistor 51 is bent, and one end of the gate of the transistor 52 is extended.

FIG. 31 shows exemplary layout pattern-dependent characteristic information 34b in view of the gate shape. The layout pattern-dependent variation condition generating means 34a of FIG. 28 extracts a gate shape of a transistor of interest from the layout information 33 based on the layout pattern-dependent characteristic information 34b, and describes information about the gate shape into the layout-dependent variation condition information 35. The variation amount generating means 29 generates variation amount information 30 based on a variation amount described in the layout-dependent variation condition information 35.

Specifically, for the transistor 50 in which both ends of the gate are bent, values of 0, 13 and −13 are applied to the typical, max and min of delvto, respectively, and values of 50, 10 and −10 are applied to the typical, max and min of Idsat, respectively. For the transistor 51 in which only one end of the gate is bent, values of 0, 25 and −25 are applied to the typical, max and min of delvto, respectively, and values of 30, 15 and −15 are applied to the typical, max and min of Idsat, respectively. For the transistor 52 in which one end of the gate is extended, values of 0, 15 and −15 are applied to the typical, max and min of delvto, respectively, and values of 30, 12 and −12 are applied to the typical, max and min of Idsat, respectively.

Since a variation amount optimal to a characteristic of each device is set, depending on the gate shape of a transistor, the precision of estimation of variations in circuit analysis can be improved.

<Number-Of-Wires-Passing-Over-Device-Dependent Variation Amount>

Next, an example in which circuit analysis is performed in view of a variation amount which varies depending on the number of wires passing over a device, will be described.

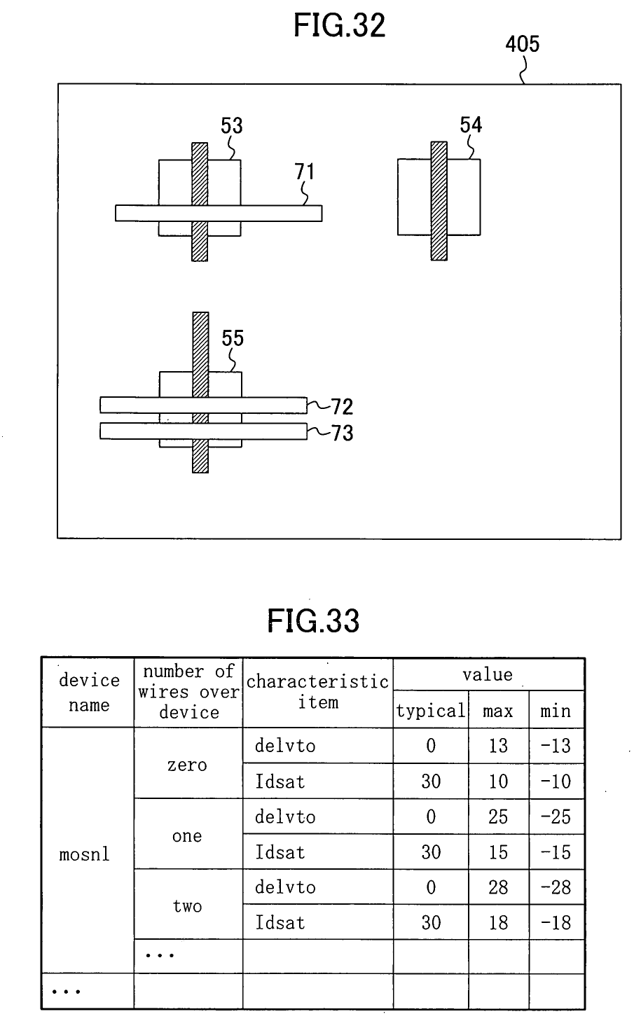

FIG. 32 shows an exemplary layout 405 corresponding to a circuit to be analyzed. The layout 405 is stored in the layout information 33 of FIG. 28. In the layout 405, 71 to 73 indicate wires passing over a transistor. When attention is paid to the numbers of wires passing over transistors 53 to 55, the transistors 54, the transistor 53, and the transistor 55 have 0, 1 and 2 wires, respectively.

FIG. 33 shows exemplary layout pattern-dependent characteristic information 34b in view of the number of wires passing over a device. The layout pattern-dependent variation condition generating means 34a of FIG. 28 extracts the number of wires passing over a transistor of interest from the layout information 33 based on the layout pattern-dependent characteristic information 34b, and describes information about it into the layout-dependent variation condition information 35. The variation amount generating means 29 generates variation amount information 30 based on a variation amount described in the layout-dependent variation condition information 35.

Specifically, for the transistor 54, values of 0, 13 and −13 are applied to the typical, max and min of delvto, and values of 30, 10 and −10 are applied to the typical, max and min of Idsat. For the transistor 53, values of 0, 25 and −25 are applied to the typical, max and min of delvto, and values of 30, 15 and −15 are applied to the typical, max and min of Idsat. For the transistor 55, values of 0, 28 and −28 are applied to the typical, max and min of delvto, and values of 30, 18 and −18 are applied to the typical, max and min of Idsat.

Since a variation amount optimal to a characteristic of each device is set, depending on the number of wires passing over a transistor, the precision of estimation of variations in circuit analysis can be improved.

<Inter-Device Distance-Dependent Variation Amount>

Next, an example in which circuit analysis is performed in view of a variation amount which varies depending on an inter-device distance, will be described.

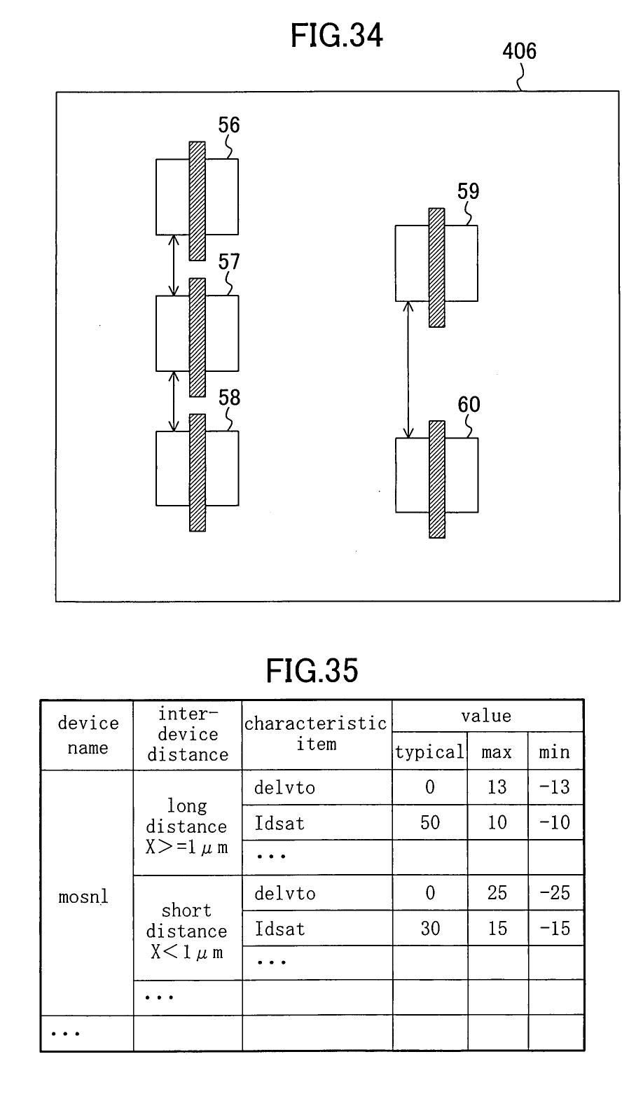

FIG. 34 shows an exemplary layout 406 corresponding to a circuit to be analyzed. The layout 406 is stored in the layout information 33 of FIG. 28. In the layout 406, when attention is paid to inter-device distances of transistors 56 to 60, the transistors 56 to 58 are arranged close to each other, and the transistors 59 and 60 are arranged distant from each other.

FIG. 35 shows exemplary layout pattern-dependent characteristic information 34b in view of the inter-device distance. The layout pattern-dependent variation condition generating means 34a of FIG. 28 extracts the inter-device distance of transistors of interest from the layout information 33 based on the layout pattern-dependent characteristic information 34b, and describes information about it into the layout-dependent variation condition information 35. The variation amount generating means 29 generates variation amount information 30 based on a variation amount described in the layout-dependent variation condition information 35.

Specifically, when the inter-device distances of the transistors 56 to 58 are less than 1 μm, values of 0, 25 and −25 are applied to the typical, max and min of delvto, and values of 30, 15 and −15 are applied to the typical, max and min of Idsat. When the inter-device distance of the transistors 59 and 60 is more than 1 μm, values of 0, 13 and −13 are applied to the typical, max and min of delvto, and values of 50, 10 and −10 are applied to the typical, max and min of Idsat.

Since a variation amount optimal to a characteristic of each device is set, depending on the inter-device distance of transistors, the precision of estimation of variations in circuit analysis can be improved.

<Transistor-Diffusion-Shared-Number-Dependent Variation Amount>

Next, an example in which circuit analysis is performed in view of a variation amount which varies depending on a transistor diffusion shared number, will be described.

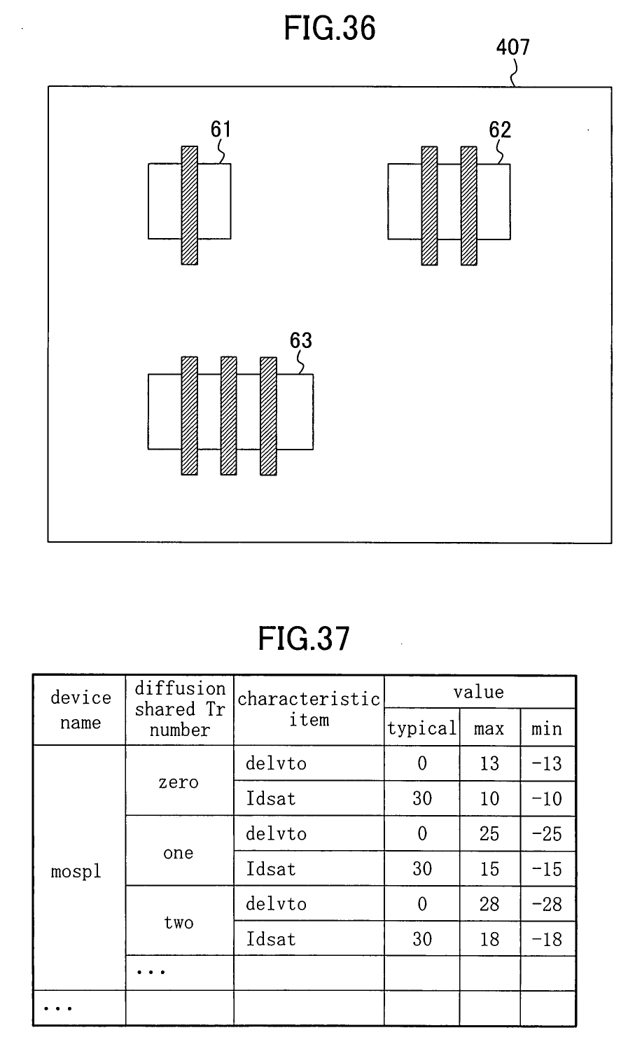

FIG. 36 shows an exemplary layout 407 corresponding to a circuit to be analyzed. The layout 407 is stored in the layout information 33 of FIG. 28. In the layout 407, when attention is paid to transistor diffusion shared numbers of transistors 61 to 63, the transistors 61, 62 and 63 have a transistor diffusion shared number of 0, 1 and 2, respectively.

FIG. 37 shows exemplary layout pattern-dependent characteristic information 34b in view of the transistor diffusion shared number. The layout pattern-dependent variation condition generating means 34a of FIG. 28 extracts the transistor diffusion shared number of a transistor of interest from the layout information 33 based on the layout pattern-dependent characteristic information 34b, and describes information about it into the layout-dependent variation condition information 35. The variation amount generating means 29 generates variation amount information 30 based on a variation amount described in the layout-dependent variation condition information 35.

Specifically, for the transistor 61, values of 0, 13 and −13 are applied to the typical, max and min of delvto, and values of 30, 10 and −10 are applied to the typical, max and min of Idsat. For the transistor 62, values of 0, 25 and −25 are applied to the typical, max and min of delvto, and values of 30, 15 and −15 are applied to the typical, max and min of Idsat. For the transistor 63, values of 0, 28 and −28 are applied to the typical, max and min of delvto, and values of 30, 18 and −18 are applied to the typical, max and min of Idsat.

Since a variation amount optimal to a characteristic of each device is set, depending on the transistor diffusion shared number, the precision of estimation of variations in circuit analysis can be improved.

<Well Size-Dependent Variation Amount>

Next, an example in which circuit analysis is performed in view of a variation amount which varies depending on a well size, will be described.

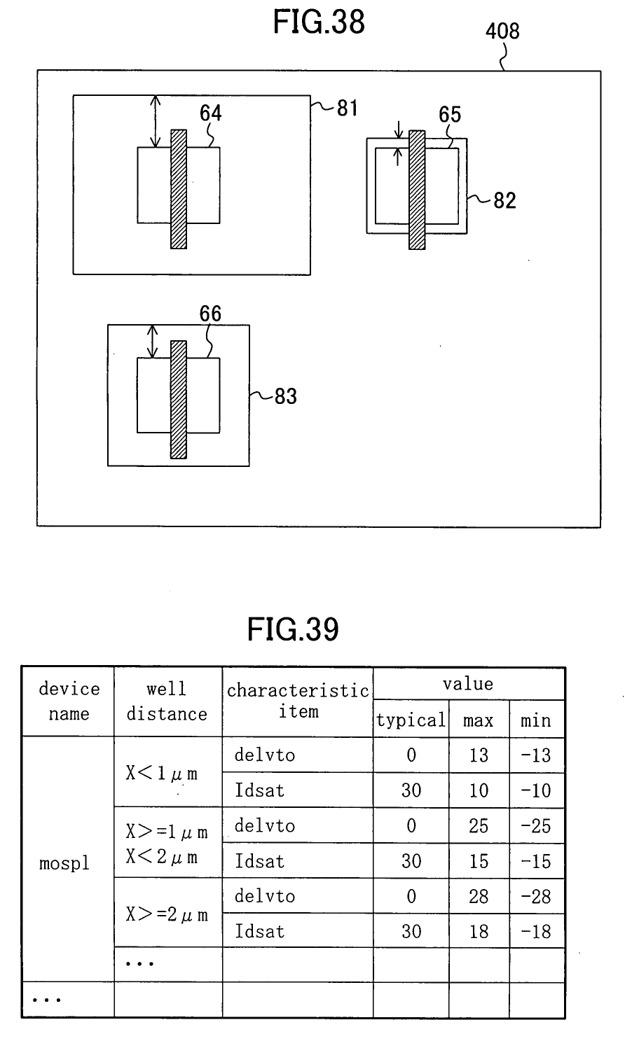

FIG. 38 shows an exemplary layout 408 corresponding to a circuit to be analyzed. The layout 408 is stored in the layout information 33 of FIG. 28. In the layout 408, 81 to 83 indicate wells of transistors 64 to 66. When attention is paid to well sizes of transistors 64 to 66, the transistors 66 to 64 have sizes which are increased in this order.

FIG. 39 shows exemplary layout pattern-dependent characteristic information 34b in view of the well size. Variation characteristics depending on a distance between a transistor and a well side are expressed. The layout pattern-dependent variation condition generating means 34a of FIG. 28 extracts the well size of a transistor of interest from the layout information 33 based on the layout pattern-dependent characteristic information 34b, and describes information about it into the layout-dependent variation condition information 35. The variation amount generating means 29 generates variation amount information 30 based on a variation amount described in the layout-dependent variation condition information 35.

Specifically, when a distance between the transistor 65 and the well side is less than 1 μm, values of 0, 13 and −13 are applied to the typical, max and min of delvto, and values of 30, 10 and −10 are applied to the typical, max and min of Idsat. When a distance between the transistor 66 and the well side is more than or equal to 1 μm and less than 2 μm, values of 0, 25 and −25 are applied to the typical, max and min of delvto, and values of 30, 15 and −15 are applied to the typical, max and min of Idsat. When a distance between the transistor 64 and the well side is more than or equal to 2 μm, values of 0, 28 and −28 are applied to the typical, max and min of delvto, and values of 0, 18 and −18 are applied to the typical, max and min of Idsat.

Since a variation amount optimal to a characteristic of each device is set, depending on the well size, the precision of estimation of variations in circuit analysis can be improved.

<Via Wire End Distance-Dependent Variation Amount>

Next, an example in which circuit analysis is performed in view of a variation amount which varies depending on a via wire end distance, will be described.

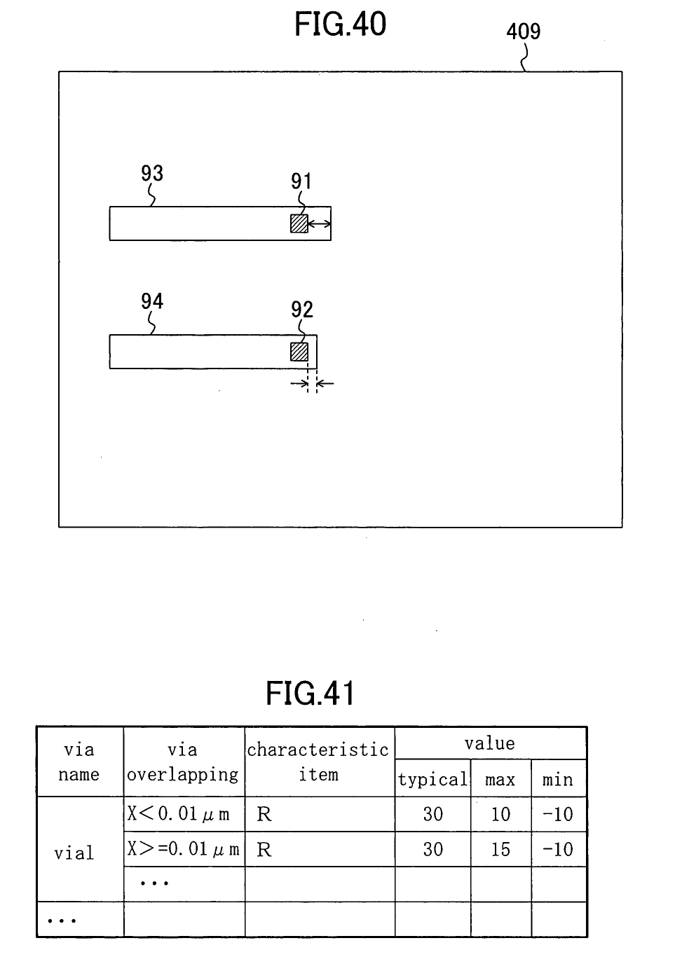

FIG. 40 shows an exemplary layout 409 corresponding to a circuit to be analyzed. The layout 409 is stored in the layout information 33 of FIG. 28. In the layout 409, 91 and 92 indicate vias, and 93 and 94 indicate wires. When attention is paid to via wire end distances of 91 to 94, the via 91 has a small distance and the via 92 has a large distance.

FIG. 41 shows exemplary layout pattern-dependent characteristic information 34b in view of the via wire end distance. The layout pattern-dependent variation condition generating means 34a of FIG. 28 extracts the via wire end distance of a via of interest from the layout information 33 based on the layout pattern-dependent characteristic information 34b, and describes information about it into the layout-dependent variation condition information 35. The variation amount generating means 29 generates variation amount information 30 based on a variation amount described in the layout-dependent variation condition information 35.

Specifically, when the via wire end distance between the via 92 and the wire 94 is less than 0.01 μm, values of 30, 10 and −10 are applied to the typical, max and min of a resistance R of the via 92. When the via wire end distance between the via 91 and the wire 93 is more than or equal to 0.01 μm, values of 30, 15 and −10 are applied to the typical, max and min of a resistance R of the via 91.

Since a variation amount optimal to a characteristic of each via is set, depending on the via wire end distance, the precision of estimation of variations in circuit analysis can be improved.

<Inter-Wire Distance-Dependent Variation Amount>

Next, an example in which circuit analysis is performed in view of a variation amount which varies depending on an inter-wire distance, will be described.

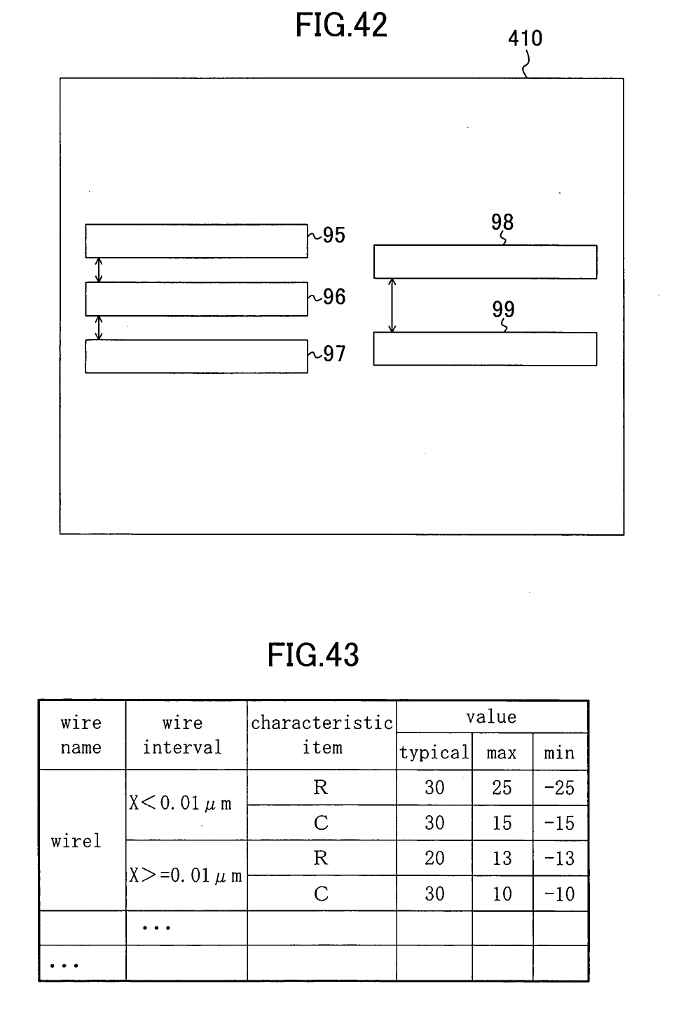

FIG. 42 shows an exemplary layout 410 corresponding to a circuit to be analyzed. The layout 410 is stored in the layout information 33 of FIG. 28. In the layout 410, 95 to 99 indicate wires. When attention is paid to inter-wire distances of the wires 95 to 99, the wires 95 to 97 are arranged close to each other, and the wires 98 and 99 are arranged distant from each other.

FIG. 43 shows exemplary layout pattern-dependent characteristic information 34b in view of the inter-wire distance. The layout pattern-dependent variation condition generating means 34a of FIG. 28 extracts the inter-wire distance of wires of interest from the layout information 33 based on the layout pattern-dependent characteristic information 34b, and describes information about it into the layout-dependent variation condition information 35. The variation amount generating means 29 generates variation amount information 30 based on a variation amount described in the layout-dependent variation condition information 35.

Specifically, when the inter-wire distances of the wires 95 to 97 are less than 0.01 μm, values of 30, 25 and −25 are applied to the typical, max and min of R, and values of 30, and −15 are applied to the typical, max and min of C. When the inter-wire distance of the wires 98 and 99 is more than or equal to 0.01 μm, values of 20, 13 and −13 are applied to the typical, max and min of R, and values of 30, 10 and −10 are applied to the typical, max and min of C.

Since a variation amount optimal to a characteristic of each wire is set, depending on the inter-wire distance, the precision of estimation of variations in circuit analysis can be improved.

<Layout Density-Dependent Variation Amount>

Next, an example in which circuit analysis is performed in view of a variation amount which varies depending on a layout density, will be described. When there is a difference in pattern density in a layer of an integrated circuit, physical characteristics of a device and a wire are affected by an influence of planarization or an optical effect.

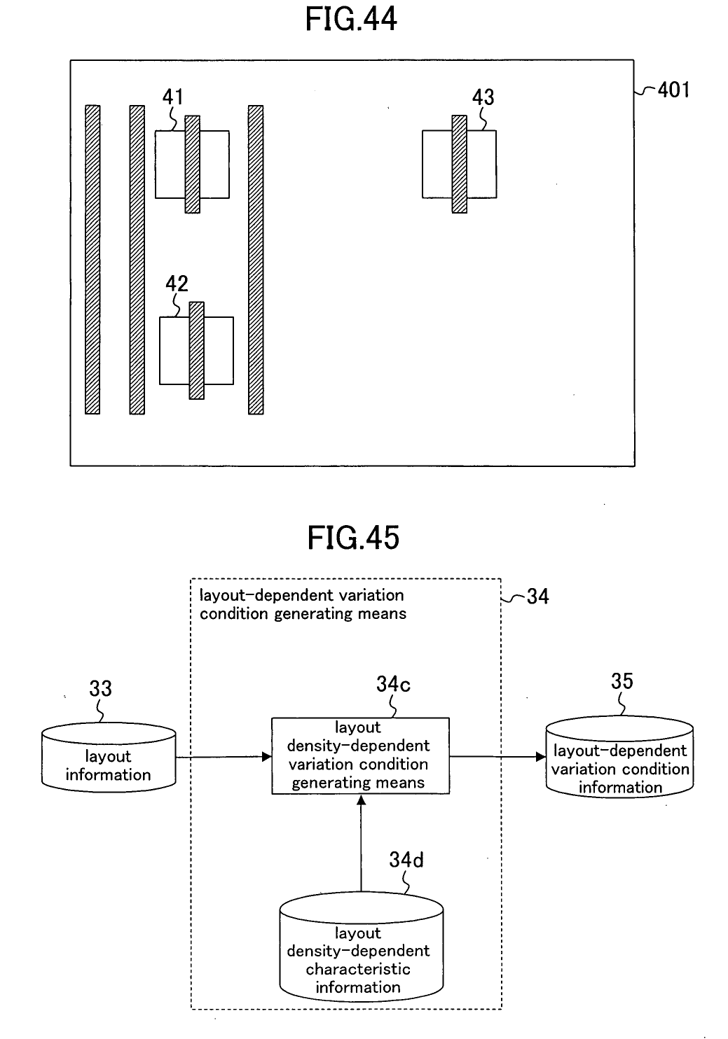

FIG. 44 shows a layout 401 corresponding to a circuit to be analyzed. The layout 401 is stored in the layout information 33. In the layout 401, when attention is paid to polysilicon densities of transistors 41 to 43, the densities of the transistors 41 and 42 are higher than that of the transistor 43.

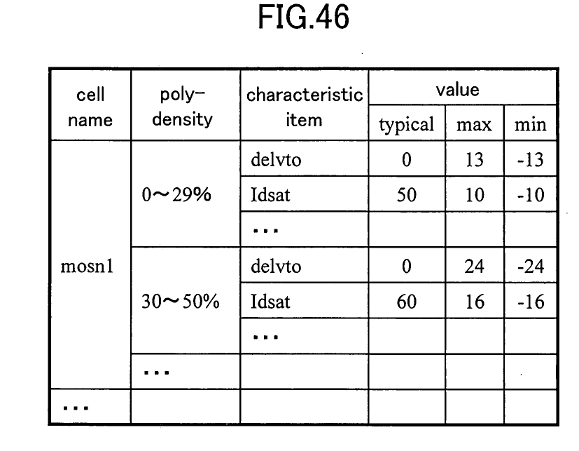

FIG. 45 is a flowchart of a layout-dependent variation condition generating method.

FIG. 46 shows exemplary layout density-dependent characteristic information 34d. A layout density-dependent variation condition generating means 34c compares the layout information 33 with the layout density-dependent characteristic information 34d. Calculation of a layout density does not require fine pattern matching or the like, and may be relatively easily achieved by a commercially available EDA tool or the like if a layout which has already been designed is provided. When it is recognized that the polysilicon densities of surroundings of the transistors 41 and 42 are high (30% to 49%), information about that is described into the layout-dependent variation condition information 35. The variation amount generating means 29 generates variation amount information 30 based on a variation amount described in the layout-dependent variation condition information 35. Specifically, for the transistor 43 having a low density, values of 0, 13 and −13 are applied to the typical, max and min of delvto, and values of 50, 10 and −10 are applied to the typical, max and min of Idsat. For the transistors 41 and 42, values of 0, 24 and −24 are applied to the typical, max and min of delvto, and values of 60, 16 and −16 are applied to the typical, max and min of Idsat.

Since a variation amount optimal to a characteristic of each device is set, depending on the layout density, the precision of estimation of variations in circuit analysis can be improved.

<Layout Distance-Dependent Variation Amount>

Next, an example in which circuit analysis is performed in view of a variation amount which varies depending on a layout distance, will be described. For characteristic items indicating in-plane distributions, such as implantation concentration, oxide film thickness, and the like, of the variations of integrated circuits, the correlation between variation characteristics thereof in devices and wires increases as the devices and the wires are provided closer to each other. Therefore, a relative variation characteristic between devices or wires depends on the distance.

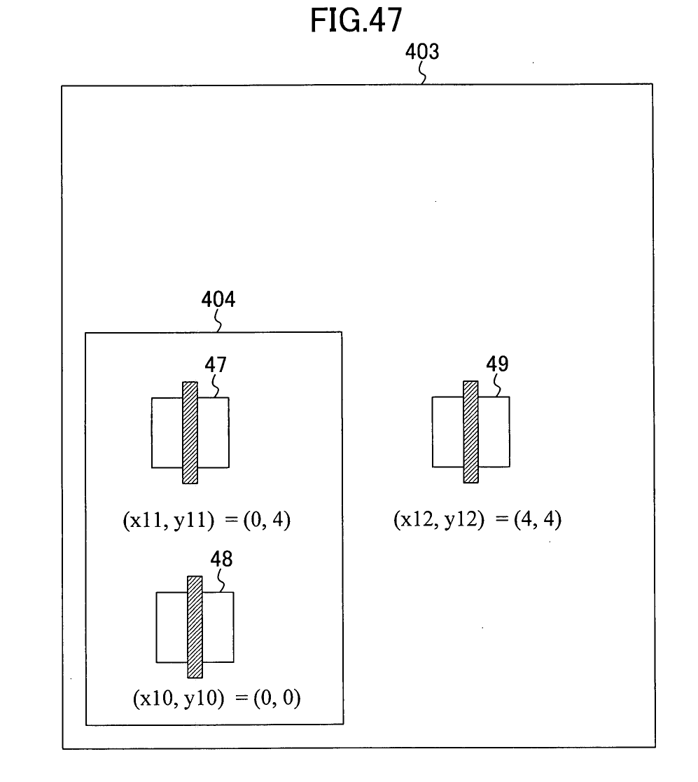

FIG. 47 shows an exemplary layout corresponding to a circuit to be analyzed. The layout 403 is stored in the layout information 33. In the layout 403, when attention is paid to a distance between each of transistors 47 to 49, the distance between the transistors 47 and 48 is 4.0, which is smaller than a distance of 5.6 between the transistors 48 and 49.

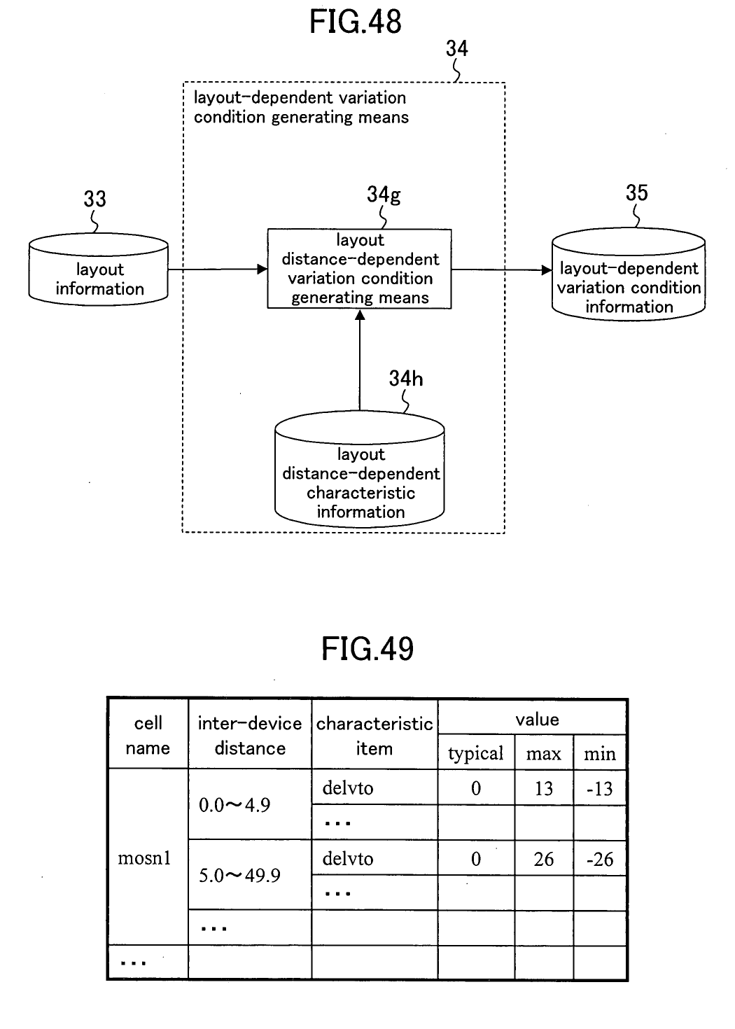

FIG. 48 is a flowchart of a layout-dependent variation condition generating method.

FIG. 49 shows exemplary layout distance-dependent characteristic information 34h. A layout distance-dependent variation condition generating means 34g compares the layout information 33 with the layout distance-dependent characteristic information 34h. A layout distance can be easily calculated from coordinates of devices. When it is recognized that the distance between the transistors 47 and 48 is small (0.0 to 4.9), information about that is described into the layout-dependent variation condition information 35. The variation amount generating means 29 generates variation amount information 30 based on a variation amount described in the layout-dependent variation condition information 35. Specifically, for the transistors 47 and 48 having a small distance therebetween, values of 0, 13 and −13 are applied to the typical, max and min of delvto. For the transistor 47 and 49, values of 0, 26 and −26 are applied to the typical, max and min of delvto.

Since a relative variation amount optimal to a characteristic of each device is set, depending on the layout distance, the precision of estimation of variations in circuit analysis can be improved.

<Layout Hierarchy-Dependent Variation Amount>

Next, an example in which circuit analysis is performed in view of a variation amount which varies depending on a layout hierarchy, will be described. In calculation of a layout distance-dependent relative variation amount, when it is difficult to extract layout coordinates of each device (e.g., a correspondence relationship between each device is different between a circuit and a layout, etc.), when it is desired to easily calculate relative variations of a plurality of devices, or the like, the calculation is more easily achieved when a variation amount is set for each block (hierarchy) having a predetermined size than when a variation amount is set depending on a distance between each device. Therefore, a variation amount of a characteristic of each device can be considered to depend on the size of a block (hierarchy) to which the device belongs.

FIG. 47 shows an exemplary layout corresponding to a circuit to be analyzed. The layout 403 is stored in the layout information 33. In the layout 403, it is assumed that a block 404 has an area of 0 to 99 and the layout 403 has an area of 100 to 299. In this case, a hierarchy 404 including transistors 47 and 48 has an area smaller than that of the hierarchy 403 including the transistors 47 and 48 and a transistor 49.

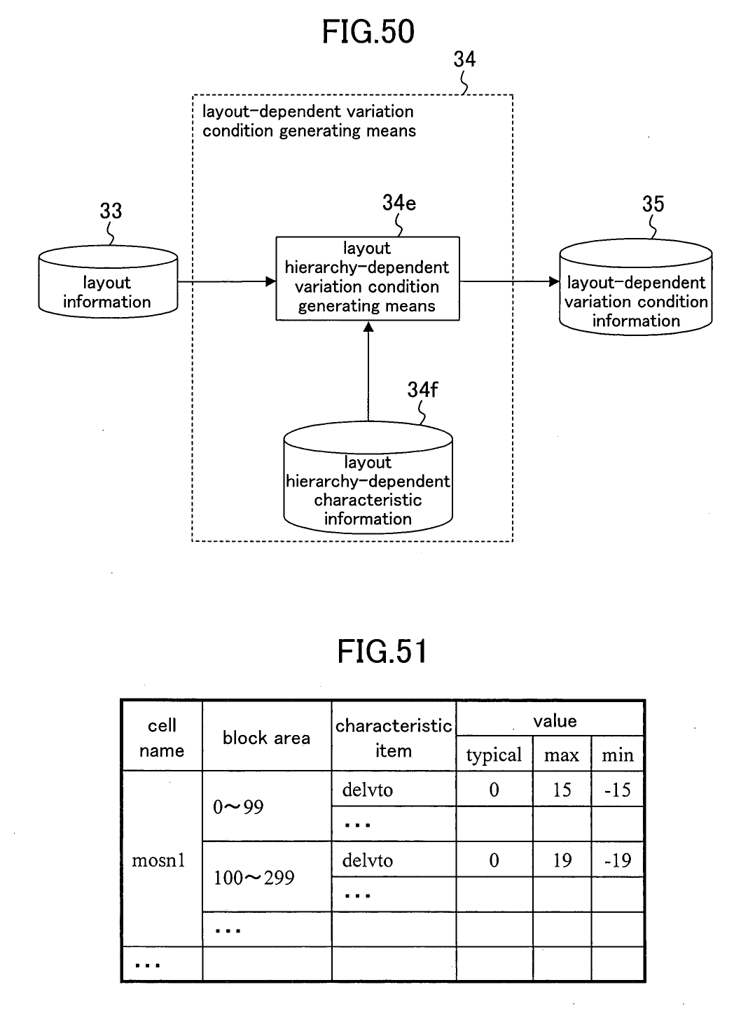

FIG. 50 is a flowchart of a layout-dependent variation condition generating method.

FIG. 51 shows exemplary layout hierarchy-dependent characteristic information 34f. A layout hierarchy-dependent variation condition generating means 34e compares the layout information 33 with the layout hierarchy-dependent characteristic information 34f. Calculation of a layout hierarchy is often previously defined by design specifications or the like. When it is recognized that the hierarchy of the transistors 47 and 48 has a small block area (0 to 99), information about that is described into the layout-dependent variation condition information 35. The variation amount generating means 29 generates variation amount information 30 based on a variation amount described in the layout-dependent variation condition information 35. Specifically, for the hierarchy of the transistors 47 and 48 having a small block area, values of 0, 15 and −15 are applied to the typical, max and min of delvto. For the transistor 49, values of 0, 19 and −19 are applied to the typical, max and min of delvto.

If the area of 100 to 299 of the layout 403 is used without considering the layout hierarchy 404, values of 0, 19 and −19 are applied to the typical, max and min of delvto for all of the transistors 47, 48 and 49, so that an excessive margin needs to be designed. According to this embodiment, since a relative variation amount optimal to a characteristic of each device is set, depending on the layout hierarchy, the precision of estimation of variations in circuit analysis can be improved.

### Fifth Embodiment

An embodiment which can be applied to each of the above-described embodiments to further improve the precision of circuit analysis, will be described below.

<Inter-Chip/Wafer/Lot Variation Amount>

It is known that variations are generally large between chips, between wafers, and between lots than in a chip. It is important to perform analysis in view of all those variations for design and verification. When variation amounts in a chip, between chips, between wafers, and between lots are represented by A, B, C and D, respectively, a total of the variation amounts can be represented by A+B+C+D.

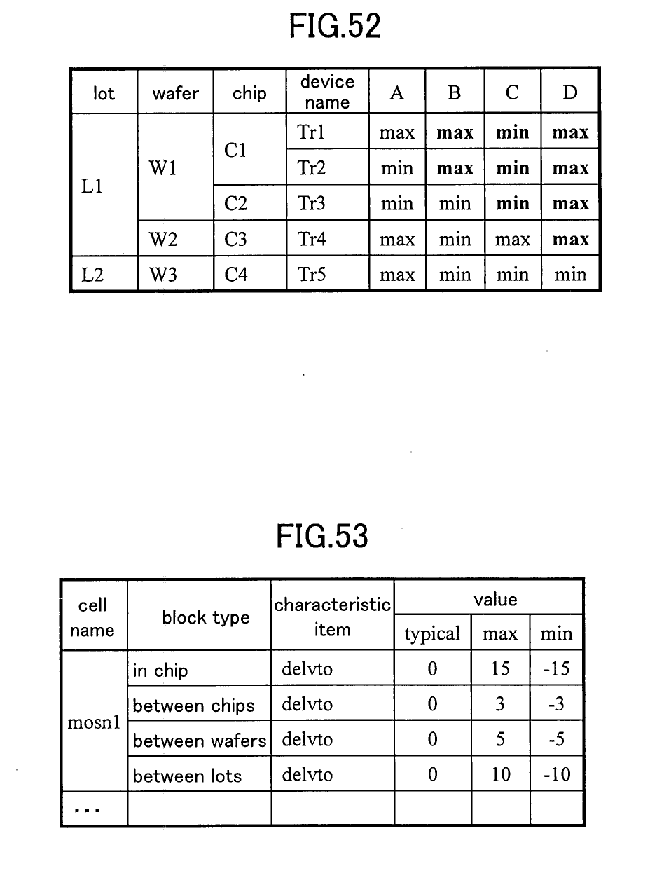

The variation condition generating means 25 sets a variation condition for each transistor so that the values of B, C and D are the same in transistors in the same chip, and the values of C and D are the same in transistors in the same wafer, and the value of D is the same in transistors in the same lot. FIG. 52 shows exemplary variation condition information 26 indicating a variation condition. Devices Tr1 and Tr2 in a chip both have the same variation conditions for B, C and D which are max, min and max. Variation amounts are calculated from process characteristic information of FIG. 53. Variation amounts of delvto of Tr1 and Tr2 are calculated by (Expression 3) and (Expression 4).

15+3−5+10=23 (Expression 3)

−15+3−5+10=−7 (Expression 4)

Thus, circuit analysis can be performed in view of variations between lots, between wafers, between chips, and in a chip, thereby making it possible to provide analysis with higher precision.

<Process Corner>

FIG. 54 shows process characteristic information 21 which indicates a process corner condition including all variation characteristics presented by a process department.

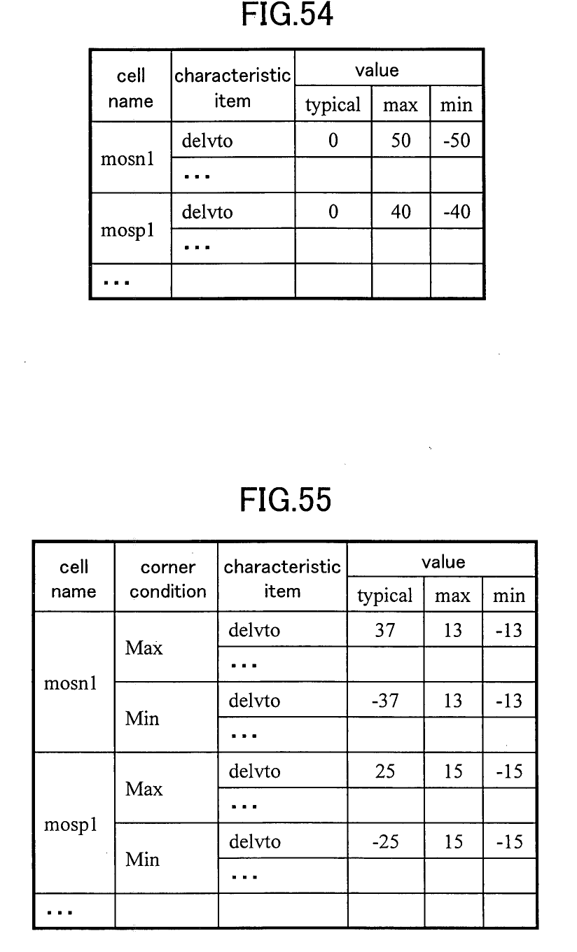

FIG. 25 shows process characteristic information 21 which indicates a relative variation amount of a pair of transistors of interest. Mosn1 has a variation amount of ±13. Here, (+50)−(+13)=(+37) and (−50)−(−13)=(−37). Therefore, if the relative variation amount of the transistor pair is shifted by ±37, the relative variation amount matches a process corner when the variation is maximum. FIG. 55 shows exemplary process characteristic information 21 which has been corrected. By performing circuit analysis at each corner based on the process characteristic information of FIG. 55, circuit analysis can be performed with precision more approximate to reality than when circuit analysis is performed using the process characteristic information of FIG. 54.

In other words, even if not all variation amounts between chips, between wafers, between lots and the like are known, then when at least a process corner condition is clear or can be assumed, circuit analysis can be performed in view of a process corner and a relative variation amount of a transistor pair, thereby making it possible to improve the precision of circuit analysis.

### Seventh Embodiment

A circuit analyzing method according to a seventh embodiment is characterized in that a feature of the above-described fourth embodiment is applied to conventional Monte Carlo simulation. In the fourth embodiment, the example in which circuit analysis is performed in view of a variation amount which varies depending on a feature of a layout of a circuit to be analyzed, has been described. In the circuit analyzing method of the seventh embodiment, for a characteristic having a variation width of the characteristics of elements included in the circuit to be analyzed, a distribution of the variations is set in view of a feature of the layout of the circuit to be analyzed. Examples of the layout feature here considered include a layout pattern (a shape pattern of a device or a wire), a layout density (a density of devices or wires), a layout distance (a distance between devices or wires), and a layout hierarchy (a size of a hierarchy to which devices or wires belong) as in the fourth embodiment. The distribution thus obtained is used to perform Monte Carlo simulation. Note that, the circuit analyzing method of this embodiment can also be implemented as a computer program or a computer which executes the program, as in the above-described embodiments.

### Eighth Embodiment

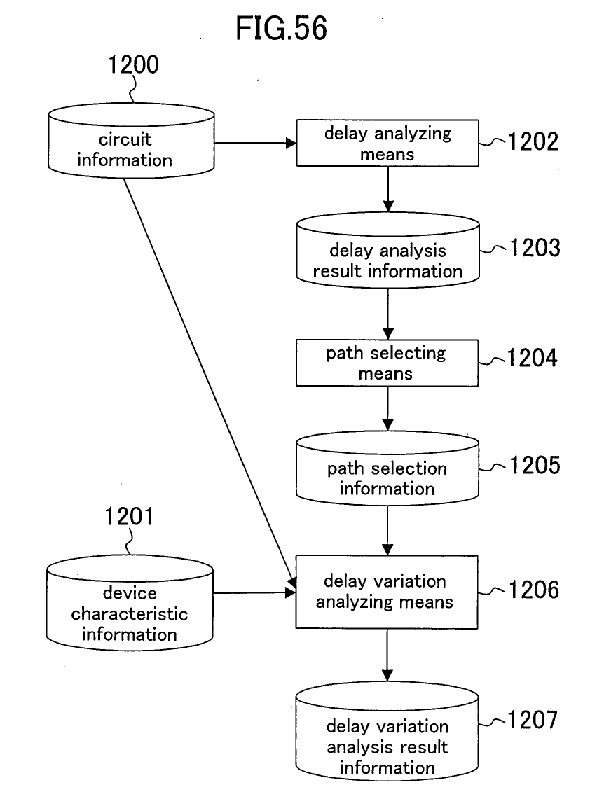

A flow of a circuit analyzing method according to an eighth embodiment is shown in FIG. 56. The circuit analyzing method of this embodiment is implemented as a program which causes a computer to execute the flow of FIG. 56 or an apparatus which executes the flow (e.g., a computer which executes the program).

<Selection of Path>

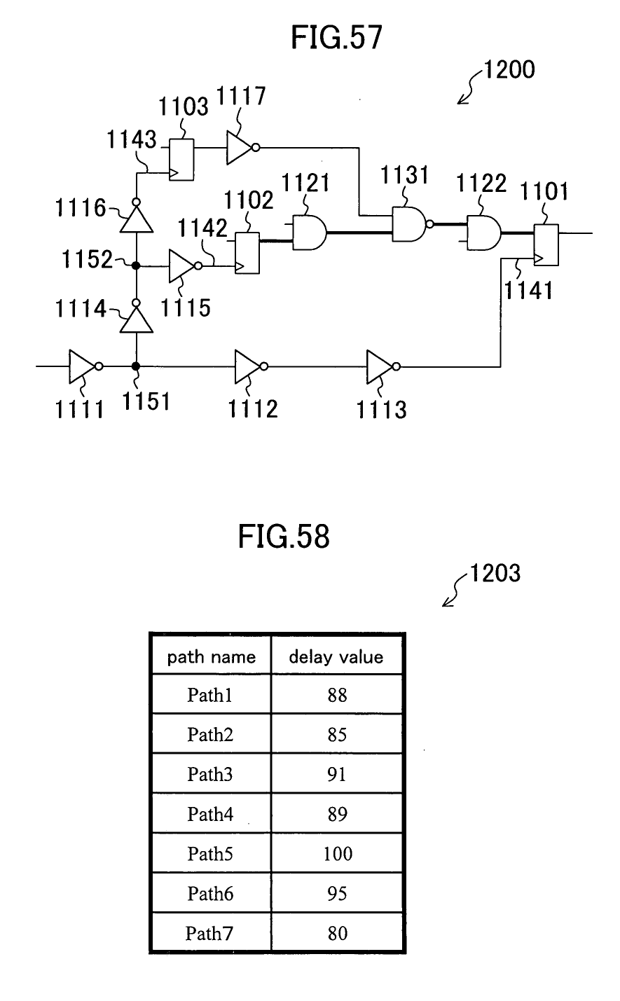

In the circuit analyzing method of FIG. 56, initially, a delay analyzing means 1202 performs delay analysis with respect to circuit information 1200 using a commercially available CAD tool or the like to output delay analysis result information 1203. FIG. 57 shows exemplary circuit information 1200 which is to be analyzed in the circuit analyzing method of this embodiment. FIG. 58 shows exemplary delay analysis result information 1203. In the delay analysis result information 1203, delay values of paths Path1 to Path7 in a circuit to be analyzed are described.

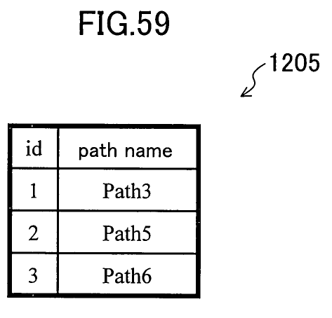

Next, a path selecting means 1204 selects a path for which delay variations are to be analyzed in view of the delay analysis result information 1203 and based on a criterion that, for example, a timing error occurs or is highly likely to occur in the path, to output the path as path selection information 1205. The path selection may be performed by the designer or alternatively may be automatically performed based on a predetermined reference (e.g., all paths whose delay values are more than or equal to a predetermined value or whose slack value is less than or equal to a predetermined value are selected). For a result of the delay analysis of FIG. 58, when “a delay value of 90 ps or more” is specified as a condition for the path selection, “Path3, Path5, Path6” are selected and output as the path selection information 1205. FIG. 59 shows exemplary path selection information 1205.

Although the example in which a path to be analyzed is selected by static delay analysis has been described n this example, any path may be selected without static delay analysis or all paths may be selected. When a path is arbitrarily selected by the designer, there is a possibility that a path which should be originally analyzed fails to be selected, however, the calculation processing time can be reduced. On the other hand, when all paths are selected, all the paths can be subjected to analysis with certainty, thereby making it possible to prevent a path from failing to be analyzed.

<Path Delay Analyzing Method Using Clock Pathway>

<Extraction of Clock Branching Point>

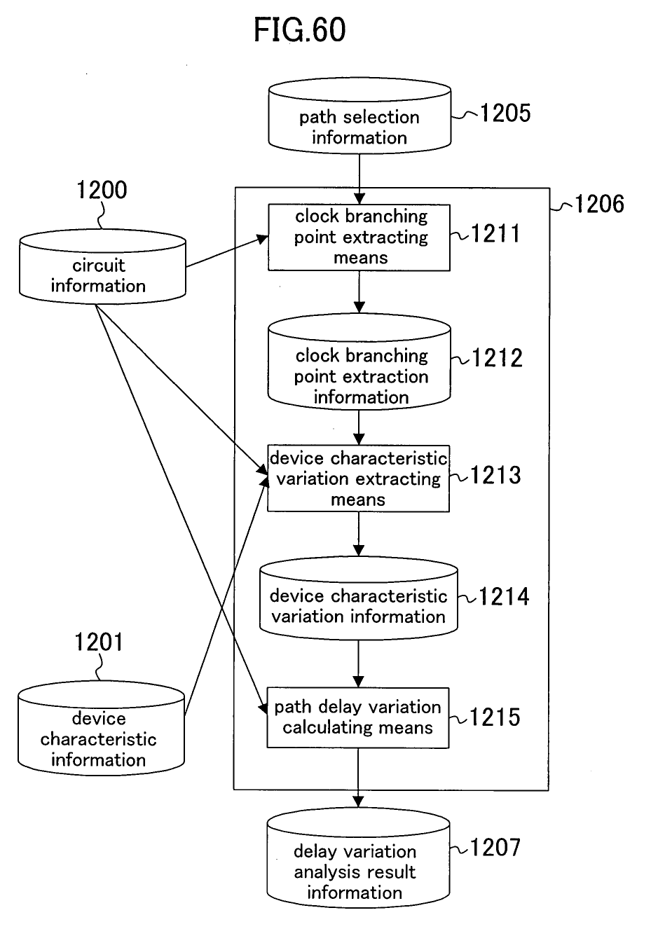

A method of calculating delay variations of a path 1102→1121→1131→1122 →1101 in FIG. 57 will be described. FIG. 60 is a flowchart of a circuit analyzing method according to the present invention where path delay analysis is performed.

In the path selection information 1205, a path to be analyzed 1102→1121→1131→1122→1101 is described. A clock branching point extracting means 1211 extracts clocks 1142 and 1141 which are input to flip-flops 1102 and 1101 which are the starting end and terminal end of the path to be analyzed.

Next, 1142 and 1141 are used to search pathways of a clock tree to extract the branching point 1151. A pathway 1151→1114→1152→1115→1142→1102→1121→1131→1122→1101 relating to the path of interest and a clock at the starting point is referred to as a data system pathway. A pathway 1151→1112→1113→1141→1101 relating to a clock at the end point of the path is referred to as a clock system pathway. The pathways of the clock system and the data system both have a starting point at the branching point 1151 and a terminal end at the flip-flop 1101 at the terminal end of the path of interest.

<Device Characteristic Information>

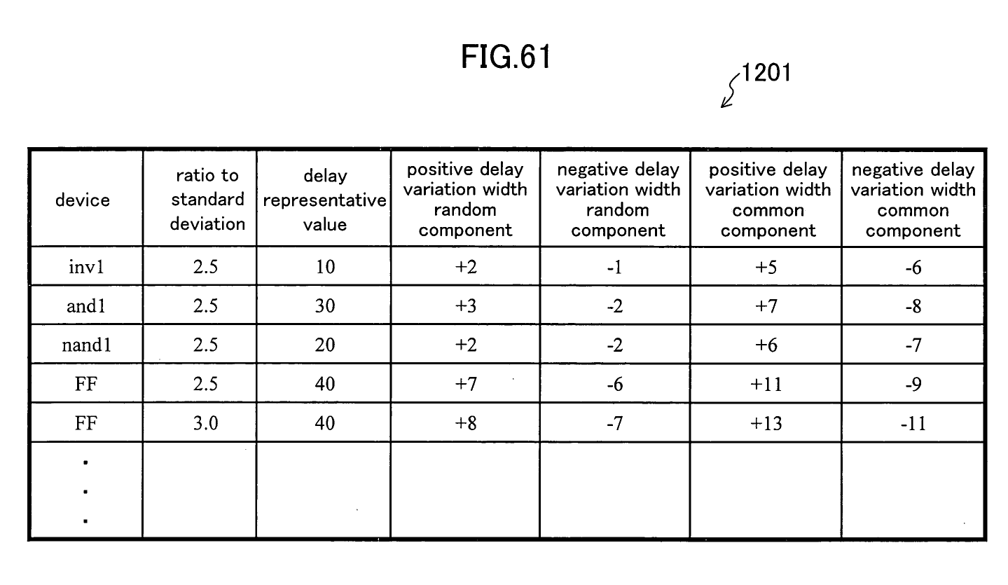

FIGS. 61 to 69 show exemplary device characteristic information 1201 used in the delay analyzing method of this embodiment.

Each device characteristic information includes a variation width of a device characteristic. In the device characteristic information of this embodiment, a variation width which differs depending on various conditions can be defined, thereby making it possible to improve the precision of calculation of delay variations. There are, for example, the following two conditions which affect the variation width of a device.

(1) Layout Condition

Variations in device characteristic due to an electrical or mechanical influence, depending on a layout condition, such as a layout pattern around a device, a connection state of a wire, a wire passing over a device, an arrangement of an I/O pad on a device, or the like.

(2) Design Condition

Variations in device characteristic due to an electrical influence of a power supply voltage, substrate noise, coupling noise or the like.

There are, for example, the following two conditions under which the variation width varies because the definition of the variation width is changed, though the variation width of an actual device does not vary.

(3) Statistical Condition

A variation width which varies depending on a statistical definition condition, such as a probability that an actual variation width falls within a specified variation width, the ratio of the variation width to a standard deviation, a deviation value, or the like.

Note that, in this embodiment, assuming that a characteristic of a device has variations with an average value of μ and a standard deviation of σ, when the variation width is represented by X, X/σ is defined as the ratio of X to the standard deviation. Specifically, the ratio of a characteristic value of μ+σ to the standard deviation is 1, and the ratio of a characteristic value of μ+3σ to the standard deviation is 3. Also, in this case, a characteristic value when the variation width of the device is X is μ+X. On the other hand, the deviation value is defined as 50+10×(X/σ). The probability is defined as a probability that the device characteristic value is less than or equal to μ+X. Specifically, when the number of all devices is N, the number of devices whose characteristic value is less than or equal to μ+X is L, and the number of devices whose characteristic value is more than or equal to μ+X is M (L+M=N), the probability is L/N.

(4) Virtual Condition

In evaluation of a path delay, if there are a number of variation components which have an influence on a characteristic of an evaluation index (the number of connected stages in a circuit is large, a process is unstable, or the like), the variations cancel each other, so that a variation width as an evaluation index is reduced. Such apparent variations depending on the number of variation components.

FIG. 61 shows an example in which a variation width of a device characteristic corresponding to the ratio of the variation width to a standard deviation is held.

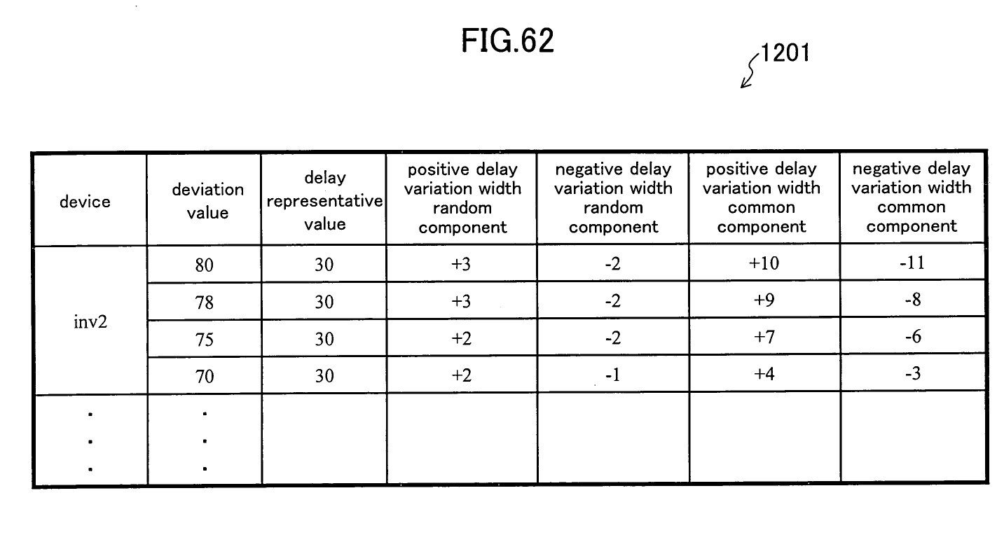

FIG. 62 shows an example in which a variation width of a device characteristic corresponding to a deviation value is held.

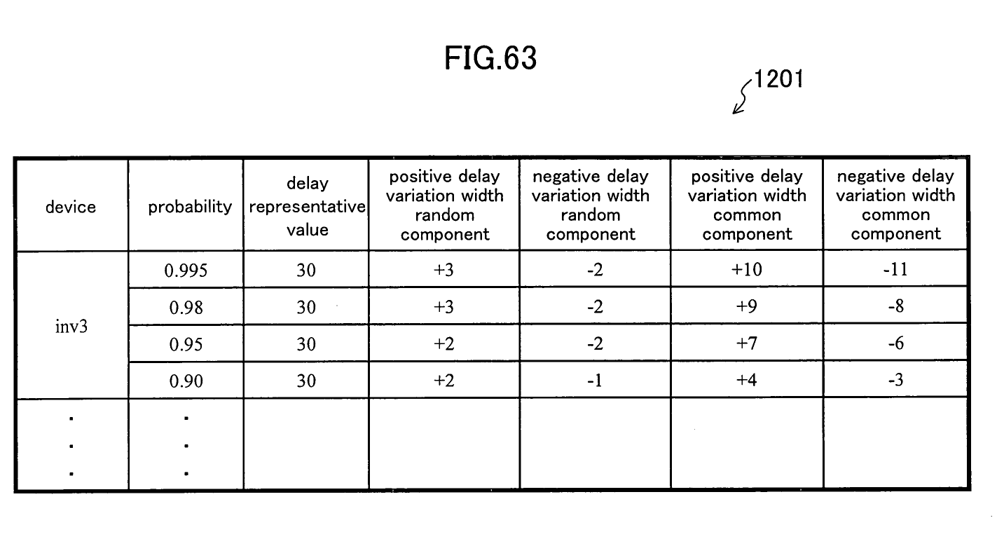

FIG. 63 shows an example in which a variation width of a device characteristic corresponding to a probability is held.

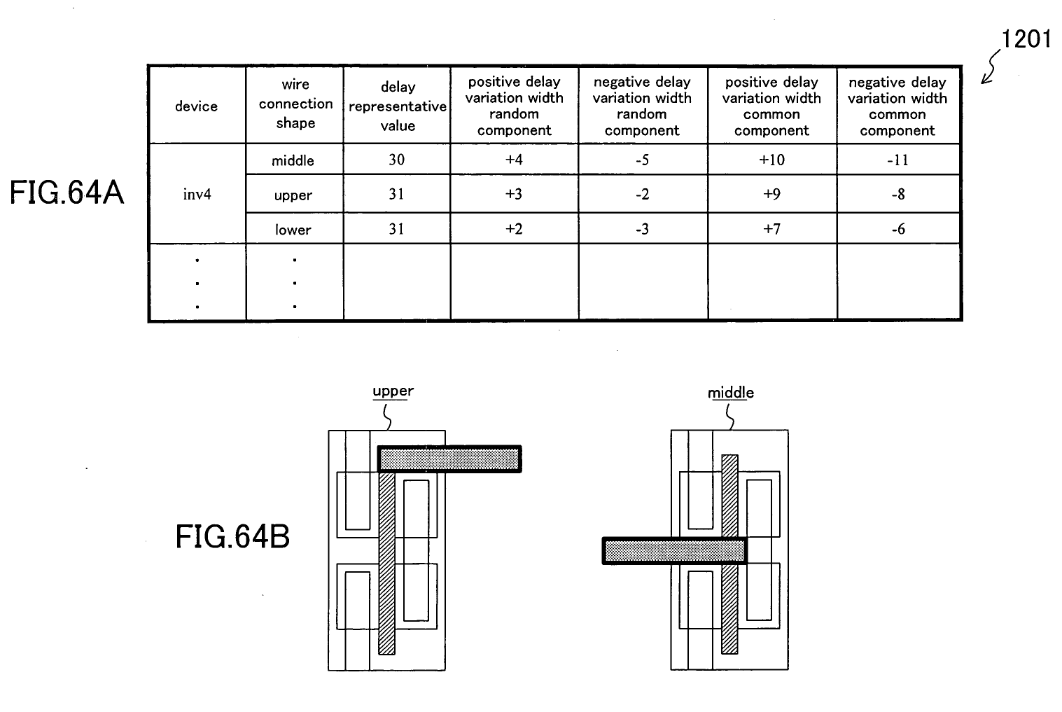

FIG. 64 shows an example in which a variation width varying depending on a shape of wire connection is held.

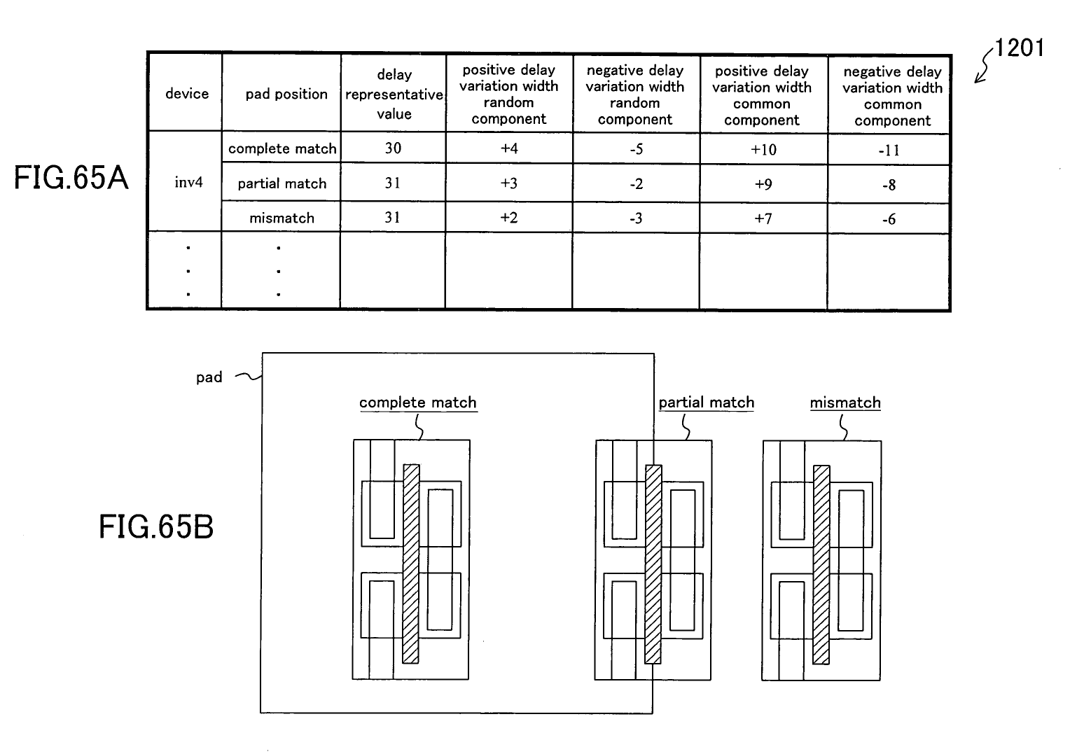

FIG. 65 shows an example in which a variation width varying depending on the presence or absence of a pad provided on a device is held.

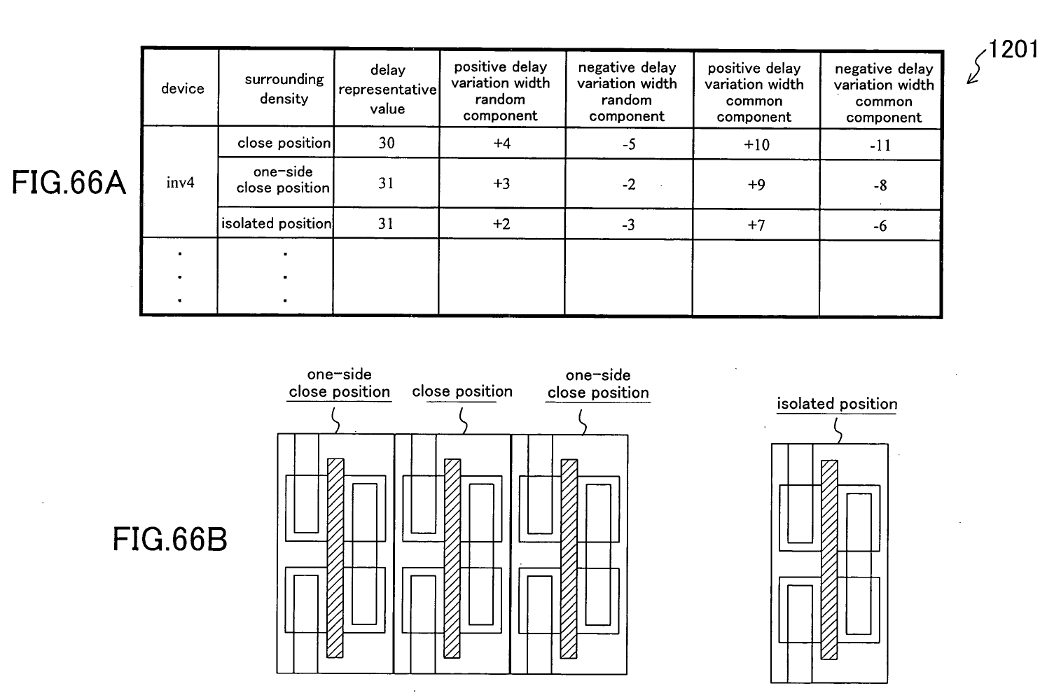

FIG. 66 shows an example in which a variation width vaying depending on a shape of a device surrounding is held.

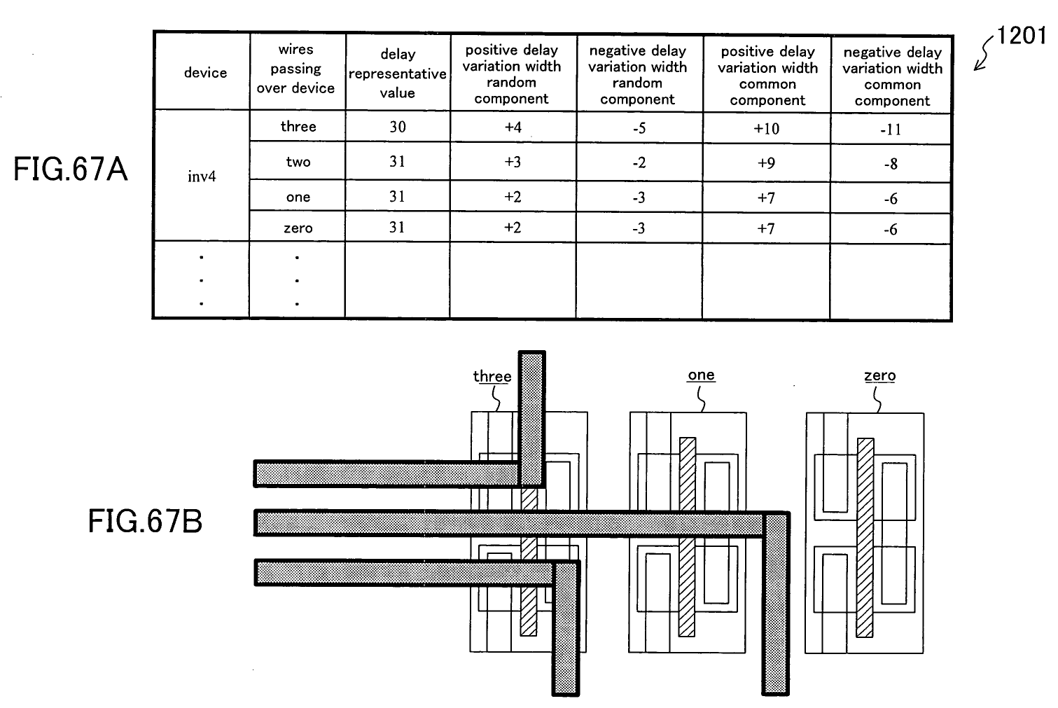

FIG. 67 shows an example in which a variation width varying depending on the number of wires passing over a device is held.

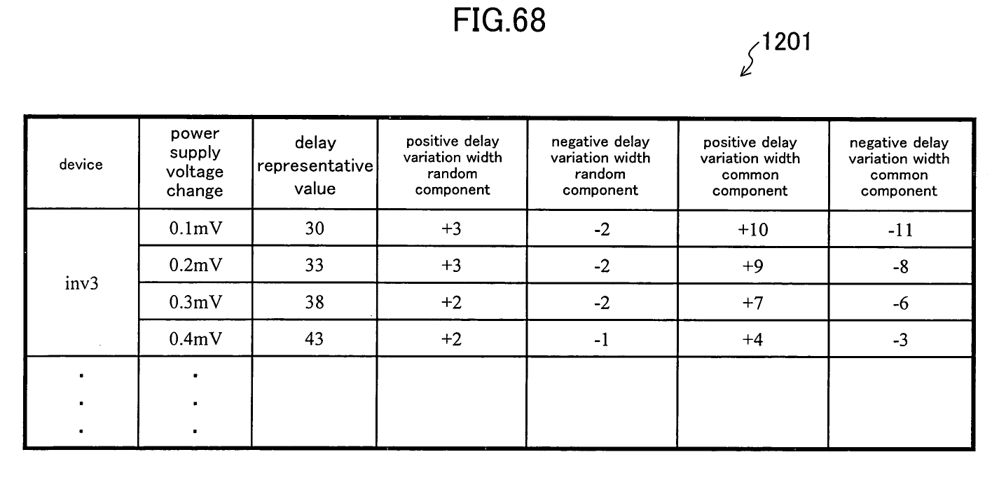

FIG. 68 shows an example in which a variation width varying depending on a change in power supply voltage is held.

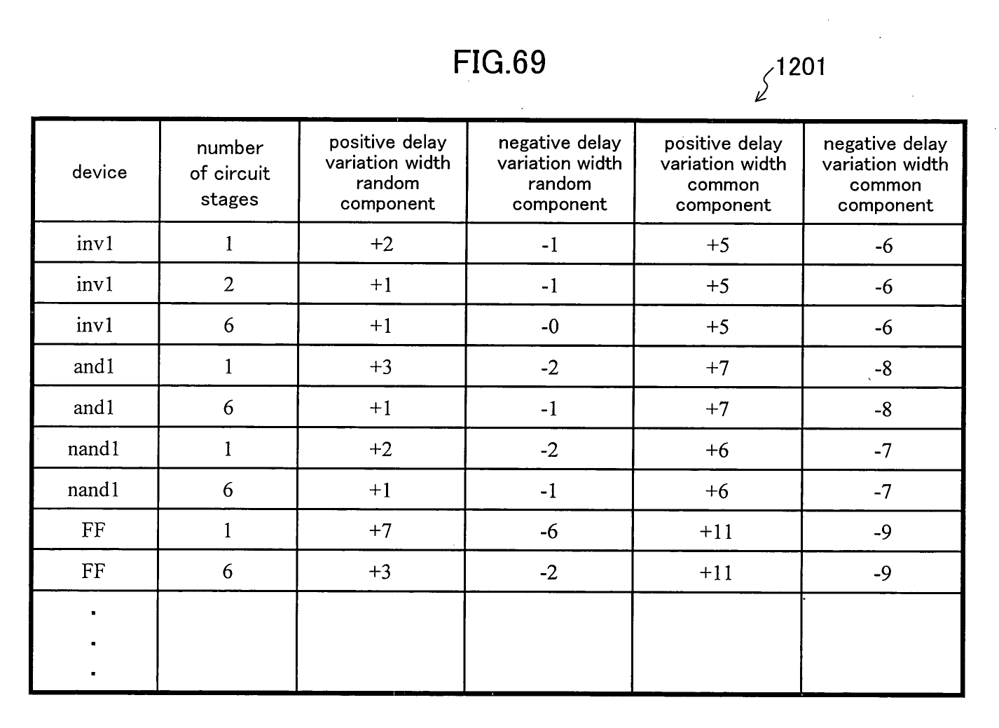

FIG. 69 shows an example in which a variation width varying depending on the number of connected stages in a circuit is held.

Although it has been assumed in FIGS. 61 to 69 that the device characteristic is a delay, the device characteristic may be other characteristics, such as an output current waveform and the like.

### <Extraction of Path Device Characteristic Variation>

Next, a device characteristic variation extracting means 1213 extracts a characteristic variation width of each device on a pathway of each of a clock system and a data system from a branching point to a terminal end of a path. Delay variations of the clock system and the data system are calculated, and a variation width of a slack is calculated.

A random variation component is a component which randomly varies from device to device and has a correlation coefficient of 0 with respect to variations of other devices. A common variation component is a component which uniformly varies in a circuit of interest and has a correlation coefficient of 1 with respect to variations of other devices. In this example, for the sake of simplicity, it is assumed that a correlation coefficient ρ is 0 and 1. Alternatively, a component having a value of 0≦ρ≦1 may be added as required.

Instead of the common variation component, an intra-block variation component, an intra-chip variation component, an inter-chip variation component, an intra-wafer variation component, an intra-lot variation component, and an inter-lot variation component may be held.

FIG. 61 shows an example in which a delay variation depending on the ratio of a variation width to a standard deviation of a variation is calculated as device characteristic information. As shown in FIG. 61, in this embodiment, a positive variation width is held separately from a negative variation width.

As shown in FIG. 61, the positive variation widths of random components of devices inv1, and1, nand1, and FF are +2, +3, +2, and +7, respectively, the negative variation widths of the random components are −1, −2, −2, and −6, respectively, the positive variation widths of common components of the devices inv1, and1, nand1, and FF are +5, +7, +6, and +11, respectively, and the negative variation widths of the common components are −6, −8, −7, and −9, respectively.

### <Characteristics Variation Analysis>

Next, a path delay variation analyzing means 1215 analyzes delay variations of each pathway in the clock system and the data system to obtain slack variations of a path of interest.

For calculation of the variation width of a slack of delay variations of the clock system and the data system, regarding the random component, the variation condition is most stringent when the variation is negative in the clock system while the variation is positive in the data system. Regarding the common component, since the common component is a component which uniformly varies in the clock system and the data system, calculation is performed with respect to a case where all variations are positive and a case where all variations are negative. Devices on a pathway in the data system are 1114→1115→1102→1121→1131→1122, and devices on a pathway in the clock system are 1112→1113, which correspond to the devices inv1→inv1→FF→and1→nand1→and1 and inv1→inv1 of FIG. 61, respectively.

Therefore, each variation component is calculated based on the values of FIG. 61 as follows.

Data system positive random variation component:

+2+2+7+3+2+3=+19

Clock system negative random variation component:

−1−1=−2

Data system positive common variation component:

+5+5+11+7+6+7=+−41

Clock system positive common variation component:

+5+5=+10

Data system negative common variation component:

−6−6−8−9−7−8=−44

Clock system negative common variation component:

−6−6=−12

A slack variation when the common variation component has a positive variation is as follows.

(+10−2)−(+41+19)=−52

A slack variation when the common variation component has a negative variation is as follows.

(−12−2)−(−44+19)=+11

When the slack value obtained by the static delay analysis is assumed to be 50, an actual slack value in view of the common variation component is −2 to 61, resulting in a timing error that the common variation component has the most positive variation.

The delay representative value of the data system is calculated from FIG. 61 as follows.

10+10+40+30+20+30 =140

The delay value of the clock system is calculated as follows.

10+10=20

Therefore, according to this embodiment, both the delay calculation and the variation width calculation can be performed without using a statistical delay analysis tool.

<Number-of-Variation-Components Dependence>

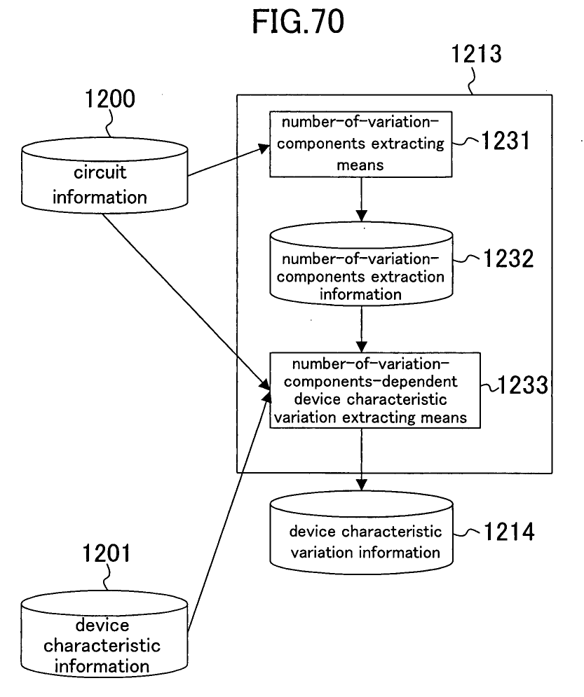

Next, an example in which a variation width of a device characteristic is changed, depending on the number of variation components, will be described with reference to a flowchart of FIG. 70.

A number-of-variation-components extracting means 1231 extracts the number of independent variation components which have an influence on an evaluation index. When a data system pathway 1114→1115→1102→1121→1131→1122 and a clock system pathway 1112→1113 are assumed to be paths to be analyzed, and variation components are assumed to be device variations, the number of circuit stages on the path can be the number of variation components. The number-of-variation-components extracting means 1231 extracts six stages from the data system pathway and two stages from the clock system pathway to obtain number-of-variation-components extraction information 1232.

Next, a number-of-variation-components-dependent device characteristic variation extracting means 1233 extracts a device characteristic variation depending on the number of variation components.

FIG. 69 describes a variation width which varies depending on the number of circuit stages. For example, when the number of circuit stages is six, +1, +1, +1, and +3 are extracted as the positive variation widths of random components of the devices inv1, and1, nand1, and FF to obtain device characteristic variation information 1214.

Random variation components in the data system and the clock system are calculated by the path delay variation analyzing means 1215 using values of the device characteristic variation information 1214 as follows.

Data system positive random variation component:

+0+0+3+1+1+1=+6

Clock system negative random variation component:

−1−1=−2

On the other hand, since the common variation component does not vary depending on the number of circuit stages, when the same values as those of the above-described calculation result are used, slack variations are calculated as follows.

Slack variation when the common variation component is positive.

(+10−2)−(+41+6)=−39

Slack variation when the common variation component is negative.

(−12−2)−(−44+6)=+24

As in the above-described examples, when it is assumed that the slack value obtained by the static delay analysis is 50, an actual slack value is +11 to +74, so that a timing error does not occur even when the common variation component has the most positive variation. In other words, by using the number-of-variation-components extracting means 1231, the number-of-variation-components-dependent device characteristic variation extracting means 1233, and the device characteristic information 1201 of this embodiment, it is possible to improve the precision of circuit analysis and correctly determine a timing error which has not actually occurred.

It is also generally known that a yield of 99.5% can be secured by guaranteeing a variation width of 3σ when the number of circuit stages is one. By utilizing the fact that a variation width of 3σ/(√N) when the number of circuit stages is N can be approximated as a variation width when the number of circuit stages is one, a variation width of 3 σ/(√N) depending on the number of circuit stages may be used when a yield of 99.5% is desired to be secured.

<Block Delay Analyzing Method>

Next, a method of calculating a delay at any point on a specified circuit will be described. Here, an example in which variations in delay of a logic device 1131 in the circuit of FIG. 57 are calculated will be described.

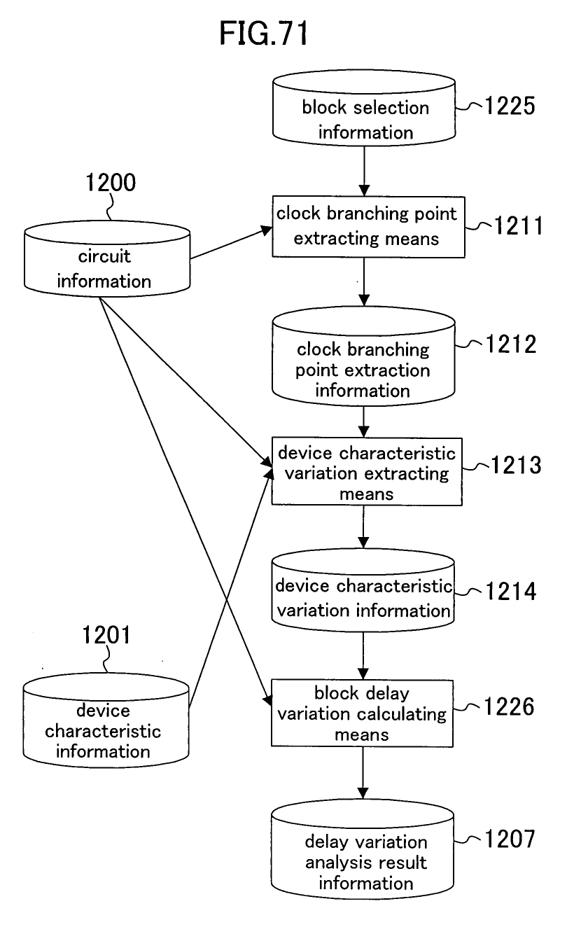

FIG. 71 is a flowchart of the circuit analyzing method of this embodiment in which block delay analysis is performed.

In FIG. 71, the logic device 1131 or a device set {1117, 1121, 1131} indicating a logic block is described in block selection information 1225.

The clock branching point extracting means 1211 extracts clocks 1142 and 1143 which enter the flip-flops 1102 and 1103 which are starting points of blocks of interest.

Next, 1142 and 1143 are used to search pathways of a clock tree to extract a branching point 1152. A pathway 1152→1115→1142→1102→1121→1131 relating to a partial path of the block of interest and a clock at the starting point is referred to as a pathway 1. A pathway 1152→-1116→1143→1103→1117→1131 relating to a partial path of the block of interest and a clock at the starting point is referred to as a pathway 2. Both the pathway 1 and the pathway 2 have the branching point 1152 as a starting point and the logic device 1131 which is subjected to circuit analysis as a terminal end. The pathways 1 and 2 thus extracted are output as clock branching point extraction information 1212.

<Extraction of Block Device Characteristic Variation>

Next, the device characteristic variation extracting means 1213 extracts characteristic variation widths of devices on the pathway 1 and the pathway 2 from the branching point 1152 to the terminal end of the block of interest.

FIG. 61 shows an example in which a delay variation under a condition that a variation width is 2.5 times larger than the standard deviation of a variation is calculated as device characteristic information.

As shown in FIG. 61, the positive variation widths of random components of the devices inv1, and1, nand1, and FF are +2, +3, +2, and +7, respectively, the negative variation widths of the random components are −1, −2, −2, and −6, respectively, the positive variation widths of common components of the devices inv1, and1, nand1, and FF are +5, +7, +6, and +11, respectively, and the negative variation widths of the common components are −6, −8, −7, and −9, respectively.

<Analysis of Block Characteristic Variation>

Next, a block delay variation calculating means 1226 analyzes delay variations of the pathways 1 and 2 to obtain a delay variation of the block of interest.

For calculation of the delay variation widths of the pathways 1 and 2, the variation condition is most stringent when both the pathways 1 and 2 have positive variations. Therefore, the calculation may be performed only when all variations are positive. The devices on the pathway 1 are 1115→1102→1121→1131 and the devices on the pathway 2 are 1116→1103→1117→1131, which correspond to the devices inv1→FF →and1→nand1 and inv1→FF→inv1→nand1 of FIG. 61, respectively.

Therefore, each variation component is calculated from the values described in FIG. 61 as follows.

Positive random variation component on the pathway 1:

+2+7+3+2=+14

Positive random variation component on the pathway 2:

+2+7+2+2=+13

Positive common variation component on the pathway 1:

+5+11+7+6=+29

Positive common variation component the pathway 2:

+5+11+5+6=+27

A maximum delay variation amount of the pathway 1 is as follows.

+14+29=+43

A maximum delay variation amount of the pathway 2 is as follows.

+13+27=+40

A delay representative value of the pathway 1 is calculated from FIG. 61 as follows.

10+40+30+20=100

A delay representative value of the pathway 2 is calculated as follows.

10+40+10+20=80

Therefore, the result of the delay analysis is as follows.

Pathway 1: representative value 100, maximum variation +29

Pathway 2: representative value 80, maximum variation +27

Note that, for the delay representative value, time points 1142 and 1143 at which a clock enters an FF can be used as references.

In this case, a delay representative value of the pathway 1 is calculated as follows.

40+30+20=90

A delay representative value of the pathway 2 is calculated as follows

40+10+20=70

In this case, the result of the delay analysis is as follows.

Pathway 1: representative value 90, maximum variation +29

Pathway 2: representative value 70, maximum variation +27

Finally, the two delay variations of the pathways 1 and 2 in the logic device 1131 are superposed. The maximum value of the variation components are superposed by the following two methods.

(1) Use of statistical calculation, such as convolution or the like

(2) Use of a maximum value of both delays

The statistical calculation has a smaller calculation error, but a longer calculation processing time. If attention is paid to the fact that a maximum value of a distribution as a result of MAX calculation of both the distributions is substantially equal to the maximum value of both the delays, the calculation can be performed with high speed and a small error by using the maximum value of both the delays.

<Case (1)>

The calculation can be achieved by:

∫∫F(x)G(y−x)dxdy

wherein F(x) and G(x) represent probability density functions of delay variations of the pathways 1 and 2.

<Case (2)>

Since 90+29=119>70+27=97, the maximum value of the delays is calculated as 119.

What is claimed is:

1. A method for analyzing a characteristic of a circuit included in an integrated circuit, comprising the steps of:
(a) applying, for an element included in a circuit to be analyzed and having a characteristic represented as values having a variation width, any value within the variation width as a representative value of the characteristic of the element; and
(b) estimating a characteristic of the circuit to be analyzed, using the representative value.

2. The method of claim 1, wherein the representative value of the characteristic of the element is a maximum or minimum value of the variation width.

3. The method of claim 1, wherein the element includes a device and/or a wire.

4. The method of claim 3, wherein the device includes any of a transistor, a resistance device, and a capacitance device.

5. The method of claim 1, wherein
step (a) includes the steps of:
(a1) changing the variation width, depending on a feature of the circuit to be analyzed; and
(a2) applying any of a maximum value and a minimum value of the variation width obtained by step (a1) as the representative value of the characteristic of the element.

6. The method of claim 5, wherein the feature of the circuit to be analyzed is a connection relationship of the element of the circuit to be analyzed.

7. The method of claim 1, wherein the variation width is a width of any of intra-chip variations, inter-chip variations, intra-wafer variations, inter-wafer variations, intra-lot variations, and inter-lot variation.

8. The method of claim 1, wherein
step (a) includes the steps of:
(a1) changing the variation width, depending on a feature of a layout of the circuit to be analyzed; and
(a2) applying any of a maximum value and a minimum value of the variation width obtained by step (a1) as the representative value of the characteristic of the element.

9. The method of claim 8, wherein the feature of the layout includes any of a shape pattern of a device and/or a wire, a density of a device and/or a wire, a distance of a device and/or a wire, a hierarchy to which a device and/or a wire belong, and a size of a hierarchy to which a device and/or a wire belong.

10. The method of claim 1, wherein, in step (a), one of a maximum value and a minimum value determined for each process of the variation width is set as the representative value.

11. A method for analyzing a characteristic of a circuit included in an integrated circuit, comprising the steps of:
(a) setting, with respect to one having a variation width of characteristics of an element included in a circuit to be analyzed, a distribution of the variations, depending on a feature of a layout of the circuit to be analyzed; and
(b) estimating a characteristic of the circuit to be analyzed, by simulation using the distribution obtained by step (a).

12. The method of claim 11, wherein the simulation is Monte Carlo simulation.

13. The method of claim 11, wherein the feature of the layout includes any of a shape pattern of a device and/or a wire, a density of a device and/or a wire, a distance of a device and/or a wire, a hierarchy to which a device and/or a wire belong, and a size of a hierarchy to which a device and/or a wire belong.

14. A method for analyzing a characteristic of a circuit included in an integrated circuit, comprising the steps of:
(a) listing, with respect to at least one having a variation width of characteristics of at least one element included in the circuit to be analyzed, variables representing a maximum value and a minimum value of the variation width as candidates for a representative value of the at least one characteristic; and
(b) selecting a representative value from the candidates listed by step (a) for each of the at least one characteristic having the variation width to generate a variation condition.

15. The method of claim 14, further comprising the step of:
(c) performing simulation by assigning process data corresponding to each variable selected as a representative value by step (b).

16. The method of claim 14, wherein the representative value of the characteristic of the element is a maximum or minimum value of variations of the characteristic.

17. The method of claim 14, wherein the element includes a device and/or a wire.

18. The method of claim 14, wherein the device includes any of a transistor, a resistance device, and a capacitance device.

19. The method of claim 14, wherein, in step (a), for one having two or more characteristics having a variation width of the elements included in the circuit to be analyzed, a combination of variables representing a maximum value and a minimum value of the variation width of each characteristic is listed as a candidate for a representative value.

20. The method of claim 14, wherein, in step (a), a variable to be listed is selected, depending on an index of circuit analysis.

21. The method of claim 14, wherein
step (a) includes the steps of:
(a1) grouping elements, depending on a feature of the circuit to be analyzed; and
(a2) listing, for each group obtained by step (a1), combinations of variables representing a maximum value and a minimum value of a variation width of a characteristic of at least one elements included in the group, as candidates for a representative value, and
in step (b), for each group obtained by step (a1), a representative value is selected from the candidates listed by step (a2).

22. The method of claim 21, wherein the feature of the circuit to be analyzed is a connection relationship of at least two elements.

23. A method for repeatedly analyzing a characteristic of a circuit included in an integrated circuit while changing characteristics of at least one element included in the circuit, comprising the steps of:
(a) selecting, for each element included in the circuit to be analyzed and having a characteristic represented as values having a variation width, any value within the variation width as a representative value of the characteristic of the element, and determining combinations of representative values of the characteristics of the element;
(b) estimating a characteristic of the circuit to be analyzed, using the combinations of the representative values; and
(c) repeatedly performing steps (a) and (b) while changing the combinations of the representative values.

24. The method of claim 23, wherein steps (a) and (b) are performed for all possible combinations of the representative values.

25. A method for analyzing a characteristic of a circuit included in an integrated circuit, comprising the steps of:
(a) extracting a characteristic having a variation width from characteristics of at least one element included in the circuit to be analyzed, based on circuit information and process characteristic information, and generating variation item information indicating a list of variables representing a maximum value and a minimum value of the variation width of the extracted characteristic as candidates for a representative value of the characteristic; and
(b) generating variation condition information including at least one variation condition which is a combination of representative values selected from the candidates listed in the variation item information for the characteristic having the variation width.

26. The method of claim 25, further comprising the step of:
(c) specifying a combination pattern of the representative values,
wherein, in step (b), variation condition information including only a variation condition corresponding to the combination pattern specified in step (c) is generated.

27. The method of claim 25, wherein, in step (b), one is randomly selected from the candidates listed in the variation item information for each characteristic having the variation width to generate variation condition information including variation conditions, the number of the variation conditions being equal to a previously specified number of repetitions of analysis.

28. The method of claim 25, wherein, in step (b), variation condition information including variation conditions is generated, the number of the variation conditions corresponding to all possible combinations of the representative values.

29. The method of claim 25, further comprising the step of:
(d) grouping elements included in the circuit to be analyzed, based on circuit information,
wherein, in step (a), for each group obtained by step (d), combinations of variables representing a maximum value and a minimum value of a variation width of a characteristic of elements included in the group are listed as candidates for a representative value.

30. The method of claim 29, wherein, in step (d), elements included in the circuit to be analyzed are grouped based on grouping information previously specifying elements to be grouped.

31. The method of claim 29, wherein, in step (d), a pattern matching grouping pattern information previously specifying patterns to be grouped is extracted from the circuit information, and elements included in the extracted pattern are grouped.

32. The method of claim 25, further comprising the steps of:
(e) generating variation amount information indicating numerical values corresponding to the candidates for the representative value listed in the variation item information, based on process characteristic information; and
(f) assigning a numerical value corresponding to a representative value in each variation condition of the variation condition information generated in step (b), based on the variation amount information, and performing circuit analysis under each variation condition.

33. The method of claim 32, wherein, in step (e), the numerical value corresponding to the candidate for the representative value is set, depending on a feature of a layout of the circuit to be analyzed.

34. The method of claim 33, wherein the feature of the layout includes any of a shape pattern of a device and/or a wire, a density of a device and/or a wire, a hierarchy to which a device and/or a wire belong, a size of a hierarchy to which a device and/or a wire belong, and a distance of a device and/or a wire.

35. A method for calculating a characteristic of a circuit included in an integrated circuit, comprising the steps of:
(a) preparing device characteristic information indicating a distribution of characteristic values of elements of the circuit;
(b) determining a variation width of a characteristic value of an element included in the circuit to be analyzed, based on the device characteristic information; and
(c) analyzing the circuit characteristic, wherein any value included in the variation width determined in step (b) is a characteristic value of the element included in the circuit to be analyzed.

36. The method of claim 35, wherein the circuit characteristic includes a delay.

37. The method of claim 35, wherein the element characteristic includes a delay or a current.

38. The method of claim 35, wherein the element includes a device, a wire, or a partial circuit.

39. The method of claim 35, wherein, in step (c), a maximum value of delays of two or more partial circuits included in the circuit to be analyzed is a delay of a circuit obtained by combining the partial circuits.

40. The method of claim 35, wherein, in step (c), a statistically calculated superposition of delays of two or more partial circuits included in the circuit to be analyzed is a delay of a circuit obtained by combining the partial circuits.

41. The method of claim 35, wherein, in step (b), the variation width is determined, depending on a specified statistical parameter.

42. The method of claim 41, wherein the statistical parameter includes any of a probability, a deviation value, a standard deviation, and a ratio to a standard deviation.

43. The method of claim 35, wherein, in step (b), the variation width is determined in view of the number of elements having an influence on an evaluation index.

44. The method of claim 43, wherein the number of the elements is the number of variation items in a process or the number of connected stages of elements on a circuit.

45. The method of claim 43, wherein
step (b) includes the steps of:
(b1) extracting the number of variation elements having an influence on an evaluation index of a circuit; and
(b2) extracting a variation width of a characteristic value of an element included in a circuit to be analyzed, from the device characteristic information, based on the number of variation elements extracted in step (b1).

46. The method of claim 35, wherein, in step (b), the variation width is determined in view of a layout condition.

47. The method of claim 46, wherein the layout condition includes any of a connection shape of a wire, the number of wires passing over a device, and a distance between an element and a surrounding shape.

48. The method of claim 35, wherein the device characteristic information includes a variation width in a positive direction and a variation width in a negative direction of the characteristic value of the element of the circuit.

49. The method of claim 35, wherein the device characteristic information includes the variation width of the characteristic value of the element of the circuit, and
the variation width includes an independent component independent on a variation in a characteristic value of another element, and a common component having correlation with a variation in a characteristic value of another element.

50. The method of claim 49, wherein, in step (b), the independent component is applied as a variation width of a characteristic value of a predetermined element included in the circuit to be analyzed.

51. A method for analyzing a characteristic of a circuit included in an integrated circuit, comprising the steps of:
(a) changing a characteristic of an element included in the circuit to be analyzed, depending on a design condition; and
(b) analyzing a circuit characteristic using the characteristic of the element obtained by step (a).

52. The method of claim 51, wherein the circuit characteristic includes a delay or a variation width.

53. The method of claim 51, wherein the design condition includes any of a power supply voltage change amount, a substrate noise amount, and coupling noise.

54. A method for analyzing a characteristic of a circuit included in an integrated circuit, comprising the steps of:
(a) changing a characteristic of an element included in the circuit to be analyzed, depending on a positional relationship between the element and an I/O pad of the integrated circuit; and
(b) analyzing a circuit characteristic using the characteristic of the element obtained by step (a).

55. The method of claim 54, wherein the circuit characteristic includes a delay or a variation width.

56. A method for analyzing a delay of a path of a circuit included in an integrated circuit, wherein delay calculation is performed with respect to a clock entering a flip-flop at a starting point of a path to be analyzed and a clock entering a flip-flop at a terminal end of the path to be analyzed, in view of a branching point of a clock transfer pathway.

57. The method of claim 56, wherein the delay calculation is performed in view of a delay variation of a circuit or delay calculation of a path in which the branching point of the clock transfer pathway is a starting point.

58. The method of claim 56, comprising the steps of:
(a) extracting the branching point of the clock transfer pathway relating to the path to be analyzed from circuit information about the circuit included in the integrated circuit and selected path information indicating the path to be analyzed;
(b) extracting a characteristic variation of a device included in the circuit to be analyzed from device characteristic information indicating a distribution of characteristic values of an element of a circuit; and
(c) calculating a delay variation of the path to be analyzed using the device characteristic variation extracted in step (b).

59. A method for analyzing a delay of at least two paths entering a device included in a circuit included in an integrated circuit, wherein delay calculation is performed with respect to a clock entering a flip-flop at a starting point of one of paths entering a device to be analyzed and a clock entering a flip-flop at a starting point of the other of the paths entering the device to be analyzed, in view of a branching point of a clock transfer pathway.

60. The method of claim 59, wherein the delay calculation is performed in view of a delay variation of a circuit or delay calculation of a path in which the branching point of the clock transfer pathway is a starting point.

61. The method of claim 59, comprising the steps of:
(a) extracting a branching point of a clock pathway relating to the circuit block from circuit information about the circuit included in the integrated circuit and selected block information indicating a circuit including the device to be analyzed;
(b) extracting a characteristic variation of the device to be analyzed, from device characteristic information indicating a distribution of characteristic values of a device of a circuit;
(c) calculating a delay variation of the circuit block using the device characteristic variation extracted in step (b).

62. A method for analyzing a characteristic of a circuit included in an integrated circuit, comprising the steps of:
(a) obtaining a circuit characteristic without considering a variation in a characteristic of each element;
(b) obtaining only a variation amount of the characteristic of each element, the variation amount being a circuit characteristic; and
(c) performing circuit characteristic analysis in view of a variation using the circuit characteristic obtained by step (a) and the circuit characteristic obtained by step (b).

63. The method of claim 62, wherein the circuit characteristic includes a delay.

64. The method of claim 62, further comprising the step of:
(d) selecting a path to be analyzed, based on the circuit characteristic obtained by step (a),
wherein, in step (c), the circuit characteristic analysis in view of the variation is performed with respect to only the path selected by step (d).

65. The method of claim 64, wherein
in step (a), a delay in a circuit is calculated from circuit information,
in step (d), a path to be analyzed is selected based on a result of delay analysis obtained by step (a),
in step (c), a delay variation of the path selected by step (d) is analyzed.

66. The method of claim 64, wherein the selection of a path in step (d) is uniquely determined based on a specified reference.

67. The method of claim 66, wherein the reference includes a slack or delay value of a path delay.
